(19) United States
(12) Patent Application Publication
(10) Pub. No.: US 2026/0170075 A1
(43) Pub. Date: Jun. 18, 2026

(54) SYSTEMS AND METHODS FOR DYNAMICALLY SHARING PORTIONS OF A WEBPAGE

(71) Applicant: Adeia Guides Inc., San Jose, CA (US)

(72) Inventors: Serhad Doken, Bryn Mawr, PA (US); Charles Dasher, Lawrenceville, GA (US); Jean-Yves Couleaud, Mission Viejo, CA (US)

(21) Appl. No.: 18/984,328

(22) Filed: Dec. 17, 2024

(51) Int. Cl. G06F 16/955; G06F 16/9535; G06Q 30/0273

(52) U.S. Cl. CPC G06F 16/9566; G06F 16/9535; G06Q 30/0275

(57) ABSTRACT

Systems and methods for selective sharing of sections of a webpage are described. An authoring device is used to mark or categorize sections of a webpage. The marks permit a sharing device to further mark or identify a subset of sections of the webpage, which are allowed for marking, with sharing preferences. HTML code may be modified based on the marked sharing preferences. Webpage sections that are marked for replacement may be replaced with secondary content items. A URL for the webpage is shared with a recipient. The URL may also include a query string reflective of the sharing preferences. Rendering is performed by the recipient device for only those sections that are marked for sharing in accordance with the modified HTML code or instructions from the query string. Engagement metrics for the rendered webpage are tracked and used for enhancing the marks or other data relating to sharing preferences.

### FIELD OF DISCLOSURE

Embodiments of the present disclosure relate to generating code for a webpage based on selections made for sections of the webpage relating to inclusion, exclusion, or replacement sharing preferences. Embodiments of the present disclosure also relate to generating and sharing a URL for a shared version of the webpage, where a voluntary or optional section of the webpage may be hidden, omitted, or replaced with secondary content based on a marking of the voluntary section.

### BACKGROUND

Sharing webpages as links is a common practice among users and everyday billions of share actions are performed. People frequently share URLs to a wide range of websites, such as websites that contain news articles, product reviews, fashion trends, sports updates, and countless other topics. This sharing occurs across various platforms, messaging apps, such as text messages, WhatsApp, google chat, emails, and social media. To share a URL, people can simply copy and paste that URL into the desired platform, such as into their text message, social media or email and send it to the recipient. When a user physically copies the URL link, link shortening services like Bitly or TinyURL may shorten the shared URL to make the URL more concise. Some platforms may also provide a share icon, which when selected, may automatically place the URL link into the user's text message, social media feed or email.

When a webpage is shared, and a recipient that receives the shared URL to the webpage selects the URL, the recipient's browser sends a request to the server hosting the webpage. The server then processes this request and sends back the HTML code, which the user's browser interprets to display the webpage. This exchange allows the sharing user to share information on a webpage and the recipient to access the webpage through their browser.

Although the process of sharing, accessing, and displaying based on interpretation of HTML code is well defined, the process of selecting which content on the webpage to share is not. When a sharing user shares a webpage, they implicitly endorse all its content, even if they disagree with certain parts or find them irrelevant. For example, in some situations, the sharing user may not agree with a section or portion of a webpage, or they may not find it interesting enough. In other situations, a section of a webpage may include information that they may feel is private enough about them such that they do not want the receiver to see or be provided an incorrect impression. As such, sharing all the content of a webpage may lead to miscommunication and unwanted sharing of information. Sharing a webpage can also be embarrassing, especially when the page contains irrelevant or inappropriate content, such as auto-playing ads. Since the ads on a webpage may be dynamically changing, current methods do not allow the sharing user to prevent certain type of ads and as such the sharing user may end up sharing all portions of the webpage, including those dynamic ads sections which may contain offensive or discomforting images. For example, a father sharing with his daughter a webpage that contains a science article might inadvertently expose the daughter to a video ad that is not age-appropriate, leading to discomfort for the parties.

There may also be other challenges that are not addressed by the current sharing practices. For example, the sharing user may not be able to selectively share specific parts of a webpage. They often have to share the entire page, including irrelevant or sensitive content. As described above, such lack of control in what to share may cause misinformation, oversharing, and sharing of irrelevant or inappropriate content.

Yet another challenge currently faced in terms of sharing webpages is that sharing of large webpages in their entirety that includes both relevant content and other content that the sharing user does not want to share can consume significant bandwidth and processing power, leading to slower loading times and increased data usage. Since modern web pages are often loaded with content pulled from many different sources including RSS Feeds, auto-play videos, the average page size has increased significantly over the past decade. As such, sharing the entire webpage, regardless of the intended content, can be inefficient, wasting storage, bandwidth, and device resources. When such a page is accessed by the recipient's browser, the browser may have to wait for all page elements to load to then render and display the page, which can introduce significant latency, frustrating the user experience.

Yet another challenge with current sharing practices is the lack of tracking and engagement metrics of the recipient provided to the author or the owner of the webpage. Similar to advertising, content authors and publishers would like to understand how users perceive their content. Data or Web analytics is a sophisticated field that helps analyze user behavior on websites. However, current data analytics tools have limitations when it comes to tracking shared content and user engagement. Since entire webpages are often shared, it is difficult to accurately determine which specific content on the webpage the recipient interacted with and enjoyed. Current tools do not provide such granular data since current sharing mechanisms share the entire webpage thereby hindering understanding of user behavior and the effectiveness of shared content.

As such, there is a need for a method and system that provides webpage sharing features that allow sharing users to share intended content and authors and owners of the webpage to track engagement more accurately with the shared content.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of a process for sharing some sections of a webpage, hiding or replacing content of other sections of the webpage, and rendering and tracking user engagement with the shared content, in accordance with some embodiments of the disclosure;

FIG. 2 is a block diagram of a system for sharing some sections of a webpage, hiding or replacing content of other sections of the webpage, and rendering and tracking user engagement with the shared content, in accordance with some embodiments of the disclosure;

FIG. 3 is a block diagram of a user device used for sharing some sections of a webpage, hiding or replacing content of other sections of the webpage, and rendering and tracking user engagement with the shared content, in accordance with some embodiments of the disclosure;

FIG. 4 is a flowchart of a process for sharing some sections of a webpage, hiding or replacing content of other sections of the webpage, and rendering and tracking user engagement with the shared content, in accordance with some embodiments of the disclosure;

FIG. 5 is an example of webpage having a plurality of sections, in accordance with some embodiments of the disclosure;

FIG. 6 is an example of webpage where sections of the webpage are selected for sharing, replacement, or hiding, in accordance with some embodiments of the disclosure;

FIG. 7 is a flowchart of a process that implements sharing preferences of sections of the webpage, in accordance with some embodiments of the disclosure;

FIG. 8 is a flowchart of a reverse process that uses user engagement analytics to mark sections of a webpage, in accordance with some embodiments of the disclosure;

FIG. 9 is a communication process between components of the system to implement sharing preferences for sections of webpage, in accordance with some embodiments of the disclosure;

FIG. 10 is an example of HTML markup for rendering sections of a webpage based on marked sharing preferences, in accordance with some embodiments of the disclosure;

FIG. 11 is an example of managing shared sections and sections with secondary content for enhancing webpage user and engagement experience, in accordance with some embodiments of the disclosure;

FIG. 12 is a flowchart of a process to recommend related sections on a webpage for marking, in accordance with some embodiments of the disclosure; and

FIG. 13 is an example of a table of relatedness between sections of a webpage, in accordance with some embodiments of the disclosure.

### DETAILED DESCRIPTION

In accordance with some embodiments disclosed herein, some of the above-mentioned limitations are overcome by techniques that include: marking, labeling, or categorizing sections of the webpages; performing sharing selections that include selecting a first subset of section(s) from the marked sections to be shared with a recipient, and selecting a second subset of section(s) from the marked sections for hiding, not sharing, or replacing with other content when shared; generating code (e.g., HTML code), generating a query string reflective of sharing selections; generating and/or sharing a URL for a shared webpage that is associated with the code and the query string; receiving a request to access the shared webpage, such as via HTML code, and based on a selection of the shared URL from a recipient; pointing to or otherwise processing the code upon receiving the request; and instructing via the query string, or otherwise providing data, to a browser of the recipient device to render the webpage based on the code, (HTML code, for instance).

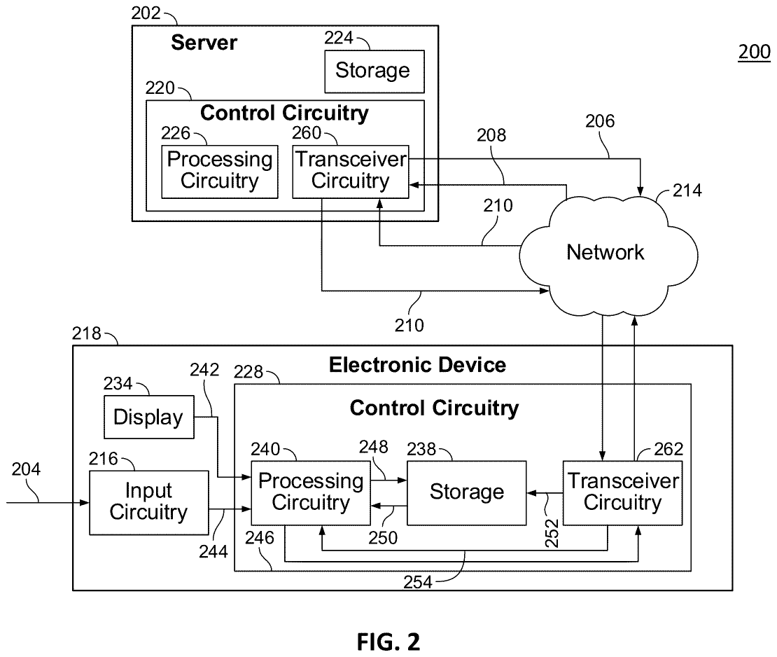

In some embodiments, an author of the webpage may markup or label sections of a webpage as required or mandatory, or voluntary or optional. The system, such as the system in FIG. 2, which may include authoring tools that allow for enhanced webpage sharing, may also suggest to the author which sections of the webpage to markup as required or voluntary. The marking may also be other varying levels of importance for each section of the webpage, such as on a scale of importance from 1-10 or some other denomination. Marking may also be used to pre-define and categorize certain sections of the webpage for sharing, and leaving other sections with more flexibility for the sharing user to select what they desire to share with a recipient. Conditional rules may also be applied when the author or the system is marking sections of the webpage. These conditional rules may involve inclusion or exclusion of certain webpage sections depending on their contextual relationship. For example, in one embodiment, selecting section B for sharing may trigger a recommendation to also select sharing of section A since it may be contextually related to section B. Likewise, deselecting section C, or selecting it not to be shared, may trigger a recommendation to exclude section D since it may be contextually related to section C or may include same genre of content that is deemed irrelevant or inappropriate to the sharing user.

In some embodiments, each section of the webpage may be identified by its unique identifier, such as an HTML id attribute. For example, if a webpage has 8 sections, each of the 8 sections may be identified by its unique identifier. When the author marks up a section of the page, such as section 6, as required, voluntary, or another type of marking, such as based on its importance or contextual relevance, the system may mark that section, e.g., section 6, in accordance with the author's markup. The system may then generate HTML code that incorporates all the marking for each section of the webpage. The system may also maintain a table that identifies each section with a unique identifier and the type of mark associated with that unique identifier based on the markings.

Once the author has marked the sections of the webpage and the webpage is placed online for user access, the sharing user, which is a user that intends to share the webpage with a recipient, may select certain sections from the already marked up webpage to share with a recipient. In some embodiments, if the author has marked a section to be voluntary, the sharing user may determine whether to share the voluntary section or mark the voluntary section for hiding or replacement such that the current content in the voluntary section is not shared with the recipient. In other embodiments, if the author has marked the section as required, then the sharing user may not have an option to not share the required section when sharing the web page. In other embodiments, the author may have marked a section based on its level of importance, and the sharing user may be able to see the importance ranking in determining whether to share the section. In yet other embodiments, the author may place conditional limitations on a particular section allowing the section to be replaced but with replacement content that is in the same genre as the content currently in that section. For example, if the author has placed conditional limitations on a section that discussed the presidential election that is written by a particular author, where the conditional limitations is to keep with the same genre, then the sharing user may replace the section with content that is also related to the presidential election from another author or select from a list of sources provided by the author. Depending on the type of marking made by the author, the sharing user may have flexibility on what sections to share and what sections not to share. Accordingly, the sharing user may further mark the sections of the webpage, which allow the sharing user to mark them, based on the sharing user's sharing preferences. In some embodiments, the sharing user may save their sharing preferences in their profile, which may be accessed by the system or the author. The sharing user may indicate in their sharing preferences, for example, share all text or all images or all videos, share certain text, images or videos, share videos or images under a particular file size, share topics XYZ, or do not share topics XYZ, do not share topics that may be rated mature and not appropriate for certain age groups, do not share pictures relating to violence, share based on relationship with recipient. They may also customize their sharing preferences as they desire or may ask the system to copy another user's sharing preferences, such as the sharing user's colleague. spouse, or friend. In some embodiments, the page author may enable a subscription, such as a tiered subscription, where each tier allows the sharing user a number of sections that can have the flexibility to change on the webpage. For example, a highest tier subscription may allow the user to change seven sections on the page to voluntary or content replacement while a lower level subscription may allow lesser flexibility with only three section changes allowed. The page author may also provide other features as part of the tiered subscription, such as a higher level subscription may be provided access to user engagement metrics while a lower tier may not.

In some embodiments, if the sharing user marks a section of the webpage, which is allowed for marking by the sharing user, for inclusion when sharing or for replacing or hiding when sharing, then the system may analyze the sharing user's sharing preferences (which may include text, image, and video sharing preferences, and/or sharing preferences for certain topic or keywords) and provide recommendations to include or exclude other contextually related sections. For example, if the sharing user deselected or marked a section that depicts a lady wearing certain type of clothing that the sharing user deems to be inappropriate, then the system, analyzing the deselection may determine whether other images on the webpage may also fall under the same level of inappropriateness and if so, suggest the deselection or removal of those sections from sharing as well. Likewise, the same may go for contextually related sections that the system may recommend for sharing based on the user's sharing preferences. Such recommendations may ensure that shared content is consistent in what is shared or prevented from sharing.

Once the sharing user selects the sections of the webpage (which were previously marked by the author or the system) based on their preferences or selections, the system may then identify or associate those sections to reflect the sharing user's selections. Accordingly, in one embodiment, the recipient's browser may review the identification of what is to be shared and render only such shared sections. If a section has not been identified to be shared, then the browser may not render that section. In this embodiment, the recipient's browser may access the HTML code and use the sharing identifications to determine what to render. For example, such sharing identification of what to share and/or what not to share may be identified in a query string. In another embodiment, the HTML code that may have been generated when the author marks the sections of the webpage may be further modified when a sharing user selects sections of the webpage to share. In this embodiment, when the recipient, with whom the webpage URL is shared, selects the URL, the modified HTML code instructs the recipient's browser on what to render, and what not to render based on the sharing user's selections. In some embodiments, the system may also maintain a table that identifies the sharing user's selections.

The sharing user may share with the recipient a URL for the shared webpage that is associated with the HTML code or JavaScript. When the recipient selects or launches the URL, such as by tapping or clicking the URL, or a related embedded webpage link, the recipient's browser may be directed to the HTML code. The recipient's browser may read the HTML code and accordingly render sections of the webpage that are permitted for sharing and either hide or replace the sections selected for hiding or replacement.

In some embodiments, the system may enable selective sharing of specific sections or portions of the webpage by encoding identifiers of chosen sections within a query string, ensuring that only the relevant content is shared and rendered when accessed by the recipient. Accordingly, the system may allow the user to select which sections or portions of a webpage to share, ensuring greater control over what is visible to others. Such capability may be implemented using several modern web technologies, offering flexibility based on the structure and complexity of the webpage. For example, a query string may be created as part of the URL. This query string is part of the URL and comes after a question mark (?). For example, “q=query+string” in the URL Https://www.XYZ.com/search?q=query+string, is the query string. The system may set an action in the query string on what is shared by the sharing user. The system may set an action in the query string on what is not shared by the sharing user. The process, in some embodiments, may include assigning a unique identifier to each section in the webpage. The unique identifier may be based on an HTML attribute.

The action, for example, may be embedded in the query string of the URL as follows: Https://www.XYZ.com/?shareSection7=true or Https://www.XYZ.com/?donotshareSection6=true. Such action may be associated with allowing sharing of Section 7 of the webpage and not allow sharing of Section 6, which may be the sharing preferences selected by the sharing user for those sections. Likewise, a query string, https://www.example.com/page?selected=content1+content2, may be used to identify that both content 1 and content 2 are selected for sharing. When the recipient selects the shared URL with the query string, the recipient's browser, to render the selected sections of the webpage on the recipient's side, may employ client-side JavaScript to process the query string. In some embodiments, the recipient's browser may perform the processing of the query string and modifying of the DOM and in other embodiments a server associated with the recipient's browser may perform the processing of the query string and modifying of the DOM. The script may read the query string, extract the identifiers of the selected sections, such as required or voluntary, shared, hidden, replaced, and dynamically hide, replace, or display the sections of the webpage accordingly. For instance, if the selected sections are content1 and content2, the script may locate elements with the corresponding id or data-share-id values and make them visible while hiding all other sections. As such, only the sections selected for sharing may be rendered in the recipient's browser. Alternatively, server-side processing may be used to achieve the same result by including only the selected sections in a query string of a URL and delivering the URL with the query string to the recipient's browser for rendering in accordance with the HTML code and instructions from the query string.

With respect to sections that are selected for replacement, in some embodiments, such sections of the webpage may be dynamically filled. There may be at least two choices in filling content in the sections being replaced. In one embodiment, if the section being replaced includes irrelevant or inappropriate content, then the system may take the attributes of the content being replaced into consideration such that the replacement content does not contain the same or similar irrelevant or inappropriate content. In another embodiment, the replacement content may be other content that is relevant to the content being replaced, but either by another author, another source, or similar content but for some of the inappropriate or irrelevant portions.

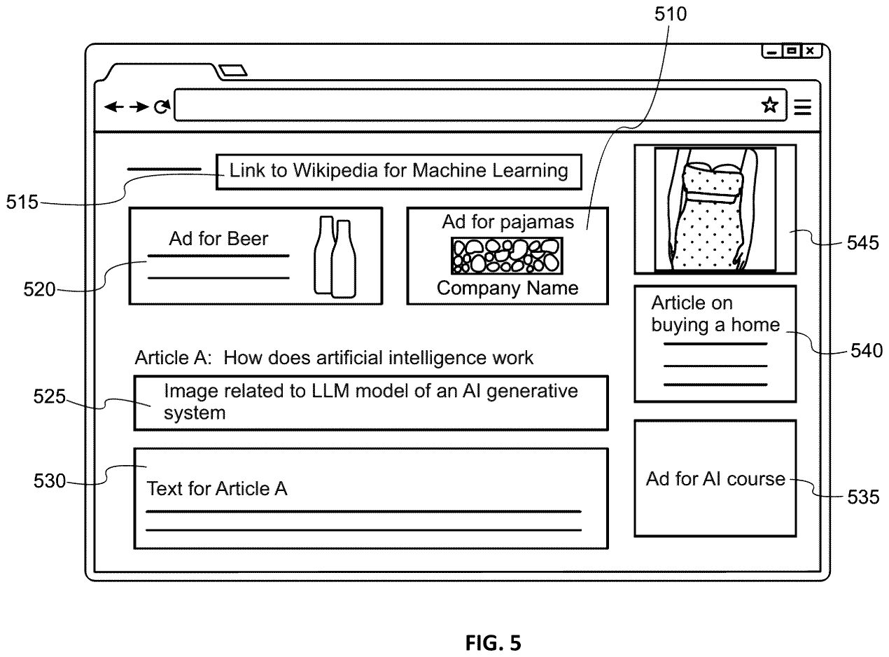

The replacement content may be selected based on various criteria, such as the original content's genre, the recipient's browsing history, or specific preferences indicated by the author or sharing user. For example, if the original content was about solar power technology, and the sharing user indicates to keep with the same genre, the replacement may also relate to solar power technology. In another example, if the original content was a woman wearing the dress as in section 545 of FIG. 5, and the sharing user indicates to not share content with the same genre, the replacement may be selected such that it is content that also does not have similar images.

In yet other embodiments, the replacement content may be content of interest to the recipient that is determined based on their profile or user browsing history. For example, if the recipient frequently views sports, the replacement might be a game update or something related to the sports of the recipient's interest. The system may also consider contextual relevance, such as suggesting home improvement tips if the core context or the primary context of the webpage is about home buying, that is if the sharing user allows the replacement content to be in the same genre or contextually related to the primary content of the webpage. In some embodiments, the author or sharing may impose restrictions, like excluding competing products or brands in the replacement content.

In some embodiments, when the author or sharing user marks up sections of the webpage to be shared, hidden, or replaced, the system can facilitate a real-time bidding process for secondary content providers, such as advertisers, to fill these vacant spaces with their content. The system may then allow secondary content providers to submit banner or video ads or other type of secondary content that meet specific criteria set by the author or sharing user. For example, the system may ensure that replacement content is not similar to the content desired not to be shared or that it aligns with the overall theme of the page or avoids competing products. The system may also provide secondary content providers with guidelines and restrictions on what content can be used to replace the current content. For example, if the sharing user is not sharing the current content in the section because of certain pictures that show nudity, the system may capture that as a restricted attribute and inform the secondary content providers to not provide nudity associated content when bidding for replacement content. Guidelines and restrictions may also prevent any ads that were already allocated a space (banner etc.) not to be skipped and declared as required during any share operation. An auto-parse of the webpage may detect banner ad locations and encapsulate them with <req-share> tag, for example, to make sure that they won't be skipped. This may be performed by the author to ensure no one ad or one company occupies more than one space on the webpage. The guidelines and restrictions may also be to manage the number of ads or secondary content in comparison to the main content or non-ad content. For example, an author may want to maintain a 70/30 percent (or another percentage) substantive content to ad content ratio on the webpage such that the ads don't overwhelm a viewer.

In yet another embodiment, the system may also classify the sections into different classes. For example, section 1 may be classified in class 1, which may be a required class that is to be shared when sharing the webpage and section 2 may be classified in class 2, which may be a voluntary class that is to be voluntary and provides the flexibility to the sharing user whether or not to share that section. One example of code that may be used to classify the sections into class 1 and 2 may be:

<div id=“section 1” class=“share-required”>
bla bla
</div>
<div id=“section 2” class=“share-voluntary”>
Lorem ipsum
</div>

Once bids are received, the system may evaluate bids based on both content quality and price, selecting the most suitable secondary content to fill the vacant section that is being replaced based on the sharing user's selections of the section(s) to share. In some embodiments, the system may allocate time slots to multiple advertisers, allowing for a rotation of secondary content within the same section. This dynamic approach may be used to enhance user engagement by providing fresh and relevant content while generating additional revenue for secondary content providers and platforms.

In some embodiments, the system may track user behavior and user engagement with the sections shared and/or replaced. Such tracking may allow the author, the sharing user, or other interested entity to gain insights into which shared sections of the webpage were engaged with, how long was the engagement, whether the section was shared, what amount of time was spent on browsing the section, or whether the section was skipped or overlooked. If authorized by the recipient, the tracking may also include determining whether the recipient browsed for other content that is similar to the content presented on the webpage after engaging with the webpage. Such engagement metrics may allow the author to optimize their content, improve page layout, and explore new monetization opportunities. In some embodiments, the system may enable dynamic A/B testing, allowing for real-time experimentation with different content variations. For example, by analyzing recipient's engagement metrics, the author may refine their content, content placement, content strategy, and provide a more customized or engaging experience.

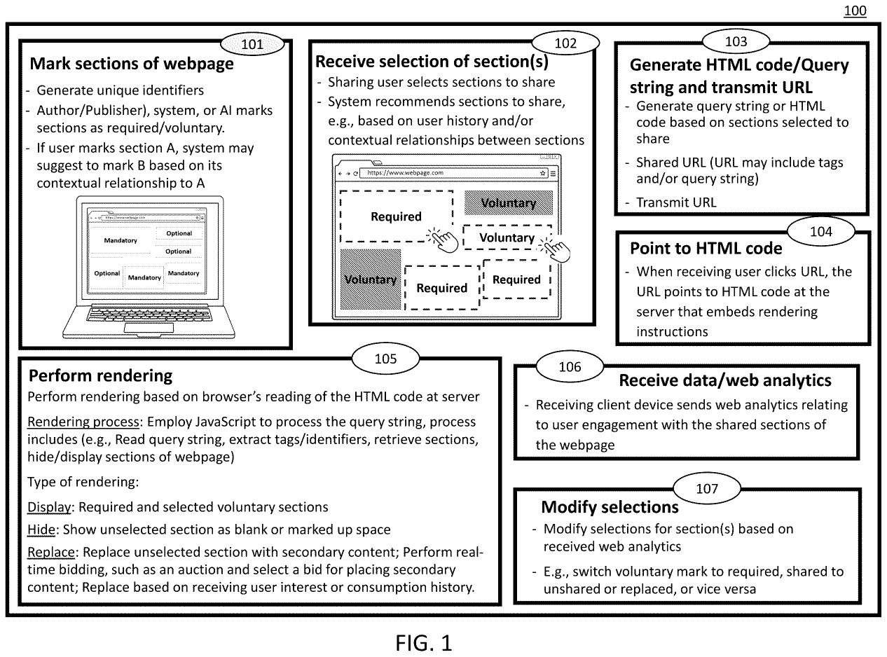

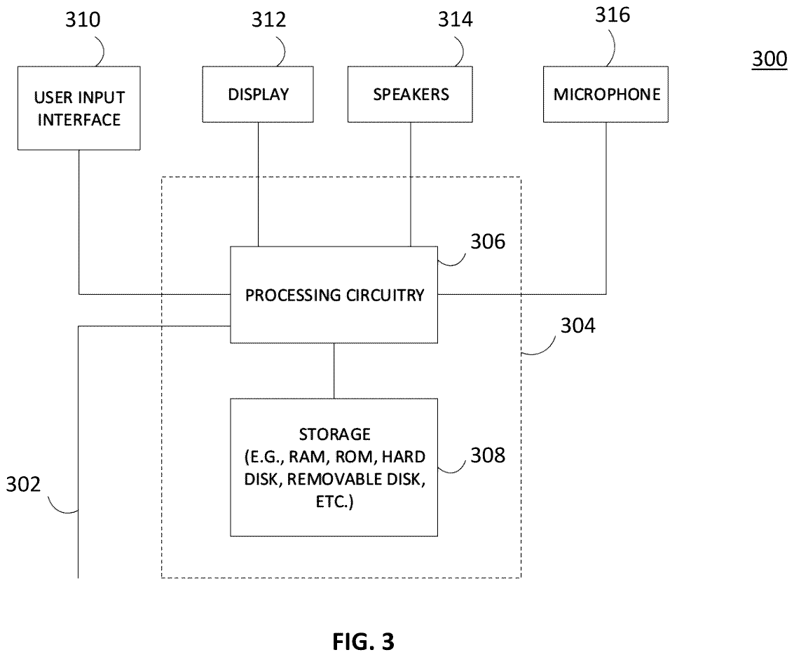

Turning now to figures, FIG. 1 is a block diagram of a process for sharing some sections of a webpage, hiding, or replacing content of other sections of the webpage, and rendering and tracking user engagement with the shared content, in accordance with some embodiments of the disclosure. The process 100 may be implemented, in whole or in part, by systems or devices such as those shown in FIGS. 2 and 3. One or more actions of the process 100 may be incorporated into or combined with one or more actions of any other process or embodiments described herein. The process 100 may be saved to a memory or storage (e.g., any one of those depicted in FIGS. 2 and 3) as one or more instructions or routines that may be executed by a corresponding device or system to implement the process 100.

Process 100 may also allow the authors to gain insights into user engagement and behavior, such as user engagement and behavior of the sharing user as well as the recipient. As referred to herein, the sharing user is a user that shares a URL of a webpage with a recipient. The sharing user may be sharing a section of the webpage with the recipient user, and the sharing may take place directly in the sharing user's browser. A new URL of the section of the webpage generated by the system may be shared over email, social media post, messaging application post or any other means of sharing a URL. Also as referred to herein, the recipient is the user that receives the URL shared by the sharing user.

Using process 100, authors of webpages may be able to enhance their content strategy and user experience. Since the embodiments discussed below provide a method of obtaining data analytics relating to user engagement, such data may be used to identify which sections of the webpages resonate most with sharing user or the recipient and which sections or content was not engaged with. Obtaining such data through data analytics may allow the authors to optimize their content, page layouts, and customize it to get better engagement. In addition, by understanding which sections are frequently skipped or shared, authors may be able to develop alternate content specifically designed for these segments of their audience thereby allowing them to maximize engagement and potentially increase revenue if the webpage is related to sale of a product or service. With the understanding obtained of which sections are frequently skipped or shared, the system may optimize the sections of the webpage such that the optimization may result in lesser bandwidth usage and prevent storage waste for content that is skipped or likely to be skipped. In some embodiments, the system may discard the skipped content to perverse bandwidth and storage resources.

In some embodiments, at block 101, a section of the webpage may be marked for sharing. The marking of the sections of the webpage may be performed by a user, such as an author or publisher, or may be suggested by the system. It may also be a combined effort between the author and the system where the system suggests the mark and the author accepts and suggestion based on which the section then gets marked as required shareable or voluntarily sharable. In one embodiment, authors may manually mark specific sections to indicate the section's importance or relevance. In one embodiment, the author may do so by highlighting the section, selecting the section by clicking the section, identifying the section by its location or coordinates on the webpage, or indicating using gestures or other means which section is being marked. In another embodiment, the author may code the HTML or use authoring tools to mark the sections, including sending voice commands or gesturing to the authoring tool to mark the section. In other embodiments, the system may leverage artificial intelligence or machine learning to analyze the author's marking behavior and history to suggest relevant marks. For example, if an author frequently emphasizes certain content, genre, themes, or products, the system may suggest marks, such as required shareable or voluntarily shareable, for sections in the webpage that contain such content.

In some embodiments, the mark may be an HTML tag or attribute or a CSS class, identifying a section as required when sharing the webpage. There may be many reasons why an author may mark the section of the webpage as required. For example, the author may have marked the section as required due to its essential role in understanding the narrative, character development, or plot progression of the webpage. The required mark may also relate to sections being contextually related to the core topic of the webpage. For example, if the webpage or the business of the webpage is a real estate firm, then a section on the webpage that relates to new real estate offerings by the company may be marked required. In some embodiments, the required mark may also be used to incorporate an RSS feed. In this embodiment, an RSS feed section of a website may be included in the required section of a webpage automatically by auto-encapsulating the RSS feed sections under the required mark umbrella. During implementation of webpage authoring tools such as Dreamweaver or WordPress or websites such as Wix.com, this functionality may be offered as default.

In some embodiments, the mark may be an HTML tag or attribute or a CSS class that identifies a section of the webpage as voluntary when sharing the webpage. As referred to herein, when a voluntary mark is associated with a section of the webpage, the system allows the flexibility to the sharing user to share or not share such a section. The sharing user may choose to share the voluntary section, hide it when the webpage is rendered for the recipient, or replace it with other content. Some of the hide and replaced options are depicted in block 103. There may be many reasons why an author marks a section as voluntary. For example, the section may not be essential to the core topic of the webpage. The section may be marked as such to allow the sharing user flexibility to customize what they want to share based on their specific interests. The author may also mark the section as voluntary if the section contains technical details, historical context, or supplementary information that is not relevant to the webpage, contains unnecessary details, is outdated, or not required for understanding some of the concepts discussed in the rest of the webpage.

In some embodiments, the author may mark a section as locked or fixed such that the section must be shared when the webpage is shared thereby limiting user flexibility for that section. In some embodiments, when the page author has locked a section, they may offer accessibility as a default mode for the locked sections. Such accessibility may include ability to pin the section in a sharing operation and ability to unlock the locked section if a higher subscription allows shared flexibility. Such a flexible sharing approach may be useful for streamlining the sharing process and ensuring that the most relevant information is highlighted. The system may also predetermine and lock, fix, or mark the sections as required. In other embodiments, the author may provide greater flexibility to the sharing user in selecting which sections of the webpage to share thereby allowing for more personalized sharing experiences such that the sharing user may select sections that are relevant and of interest to them.

In some embodiments, the author may mark the sections with varying levels of importance for each section of the webpage, such as on a scale of importance from 1-10 or some other denomination. For example, the author may indicate that sections marked 1-3 must be shared, sections marked 4-7 are suggested for sharing but can be replaced with similar content, and sections marked 8-10 are voluntary and the sharing user may decide whether to share, hide, or replace. The author may also mark certain sections as replaceable but indicate that they may only be replaced by a selection provided by the authors, such as 3 other content items that can be used to replace the section. The author may also classify the sections into different classes. For example, section 1 may be classified in class 1, which may be a required class that is to be shared when sharing the webpage and section 2 may be classified in class 2, which may be a voluntary class that is to be voluntary and provides the flexibility to the sharing user whether or not to share that section.

One example of code that may be used to mark or label sections 1 and 2 as required, such as by using classes, marks, or attributes of the sections, may be:

With classes:
<div id=“section 1” class=“share-required priority1”>
bla bla
</div>
<div id=“section 2” class=“share-required priority2”>
Lorem ipsum
</div>
With marks:
<req-share priority=“1”>
<div id=“section 1”>
bla bla
</div>
</req-share>
<req-share priority=“2”>
<div id=“section 2”>
Lorem ipsum
</div>
</req-share>
With attributes:
<div id=“section 1” class=“share-required” priority=“1”>
bla bla
</div>
<div id=“section 2” class=“share-required” priority=“2”>
Lorem ipsum
</div>

One example of code that may be used to mark or label sections 1 and 2 as voluntary, such as by using classes, marks, or attributes of the sections, may be:

<div id=“section 1” class=“share-voluntary priority1 non-replaceable”>
bla bla
</div>
<div id=“section 2” class=“share-voluntary priority2 replaceable”>
Lorem ipsum
</div>

Although some examples of marks or labels that the author can add to each section are provided, the embodiments are not so limited, and the author may add other types of marks to the section of the webpage.

When an author marks a section, the system may analyze the marking and provide additional recommendations. The system may apply conditional rules to suggest markings for other sections in the webpage. The system may automatically perform implementation of such conditional rules or do so if the author selects an option to apply the conditional rules. When conditional rules are applied, the system may analyze the context of the section marked, obtain attributes of the section and the marking, and determine whether other sections in the webpage are contextually related to the section marked. For example, in one embodiment, an author marking section B for required when sharing, such as by using an authoring tool, may trigger a recommendation in the authoring tool to also mark section A for required when sharing since section A may be contextually related to section B. Likewise, marking section C as voluntary when sharing may trigger a recommendation to also mark section D as voluntary when sharing since it may be contextually related to section C.

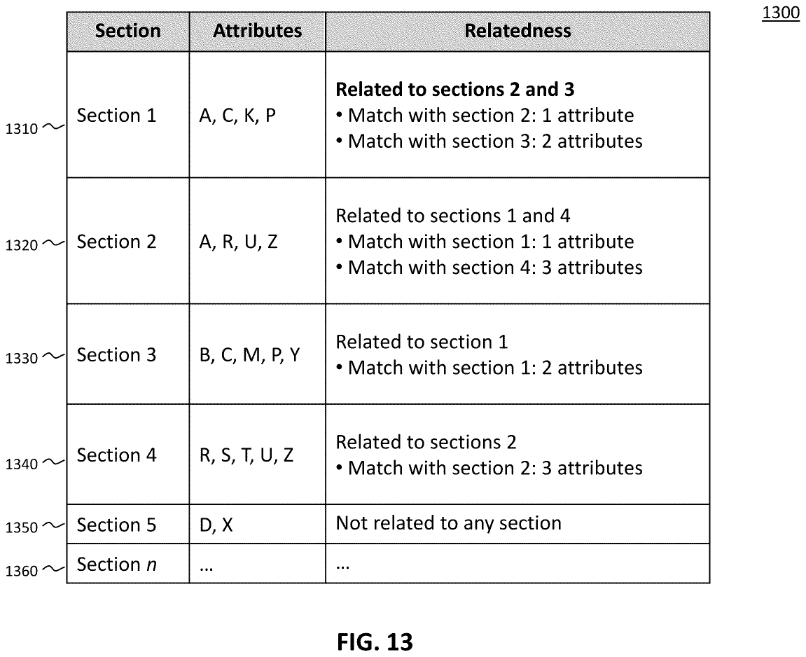

Once the author marks up a section of the page with marks such as with as required, voluntary, level of interest, contextually related to another section, replaceable but with another author provided alternative content item, the system may generate HTML code that incorporates all the marking made by the author (or system) for each section of the webpage. The system may also maintain a table that identifies each section with a unique identifier and the type of mark associated with that unique identifier based on the markings. Similar to FIG. 13, the table may include a first column for the section, a second column for the unique identifier for the section, and a third column for marks associated with the unique identifier. The table may provide the author an overview of all sections, identifiers, and marks in one glance. The HTML code when read by a browser may provide instructions on how to render each marked section.

At block 102, once the author has marked specific sections of the webpage as voluntary or required, or some other marking such as based on levels of interest as described earlier, the system may receive a selection of section(s) for sharing or not sharing by the sharing user. In other words, the sharing user may further screen and select the content to be shared after the author's marking. By doing so, the sharing user may have the flexibility to include or exclude voluntary sections based on the sharing user's or the recipient's interests, or the sharing user and recipient relationship, such as father-daughter, work colleague, for which sections to share or not share. For example, if a section is marked as voluntary by the author, the sharing user may select to either include the voluntary section in the shared content or exclude the voluntary section entirely and replace it with other content.

In other embodiments, if the author has marked the section as required, then the sharing user may not have an option to not share the required section when sharing the web page. If that is the case, in certain embodiments, the sharing user may request the author to change the marking from required to voluntary.

In other embodiments, the author may have marked a section based on its level of importance, and the sharing user may be able to see the importance ranking and recommendations in determining whether to share the section. In yet other embodiments, the author may place conditional limitations on a particular section allowing the section to be replaced but with replacement content. In some examples, the replacement content is in the same genre as the content currently in that section. For example, if the author has placed conditional limitations on a section that discussed the presidential election that is written by a particular author, where the conditional limitations is to keep with the same genre, then the sharing user may replace the section with content that is also related to the presidential election from another author or select from a list of sources provided by the author. Depending on the type of marking made by the author, the sharing user may have flexibility on what sections to share and what sections not to share. Accordingly, the sharing user may select the sections of the webpage, which are allowed for selection by the sharing user, based on the sharing user's preferences.

In some embodiments, if the sharing user selects a section of the webpage, which is allowed for marking by the author, for inclusion during sharing or for replacing or hiding when sharing, then the system may analyze the sharing user's sharing preferences and provide recommendations to include or exclude other contextually related sections. For example, if the sharing user deselected or selects a section for removal, hiding or replacement, such as for a section that depicts a lady wearing certain type of clothing that the sharing user deems to be inappropriate, then the system, analyzing the deselection may determine whether other images on the webpage may also fall under the same level of inappropriateness and if so, suggest the deselection or removal of those sections from sharing as well. Likewise, the same may go for contextually related sections that the system may recommend for sharing based on the user's sharing preferences. Such recommendations may ensure that shared content is consistent in what is shared or prevented from sharing.

In some embodiments, when a sharing user identifies a section of a webpage, such as for sharing or for not sharing, the system may automatically recommend additional contextually related sections to include in the selection. The system may leverage AI to make such recommendations by automatically identifying contextually related content in other sections. For example, in one embodiment, selecting section B for sharing may trigger a recommendation to also select sharing of section A since it may be contextually related to section B. Likewise, deselecting section C, or selecting it not to be shared, may trigger a recommendation to exclude section D since it may be contextually related to section C or may include same genre of content that is deemed irrelevant or inappropriate to the sharing user.

In some embodiments, the system may also generate a visual representation of the relationships between the selected section and other sections of the webpage, such as a relationship graph, tree, or nodes based on the degree of contextual similarity or similarity of topic with the selected section. The system may also display weights based on the degree of similarity thereby providing the sharing user data to allow them to make informed decisions about which additional sections to share or not share to stay consistent.

The selection of the sharing user, what to share and not to share, may be to a subset of the sections that the author has marked. For example, the sharing user may select to include a first subset of sections from the marked sections to be shared with a recipient and a second subset of sections from the marked sections for hiding, not sharing, or replacing with other content when shared. For example, if the author has marked 6 sections and required and 5 sections as voluntary, then the required sections may be restricted such that they cannot be deselected for sharing, however, the sharing user may select 3 sections, a subset of the 5 voluntary sections, for sharing, 1 of the 5 sections for hiding, and 1 of the 5 sections for content replacement. As such, the sharing user may have different sharing preferences for each section for which sharing flexibility is allowed by the author.

The selection at block 102 by the sharing user may include hiding a section, replacing a section, or sharing a section. When the sharing user decides to hide a section of the webpage, the hidden section may be displayed as blank space or selected space, such as with a text indicating restricted. When the sharing user decides to replace a section of the webpage and selects it as such, the section may be replaced with other content. The sharing user may further have the option to have the replacement content be in the same genre or contextually related to the content being replaced or may select to have replacement content that is not in the same genre or contextually related to the content being replaced, especially if the content to replace is deemed offensive or inappropriate by the sharing user and selected or identified as such. In some embodiments, the sharing user may be able to see the replacement content before the sharing. For example, the replacement content may be displayed on the sharing user's user interface and only upon the sharing user's approval may it be shared with the recipient. In other embodiments, the sharing user may indicate their genre preferences using the user interface, or such genre preferences may be obtained from their profile, and the system or server may perform checks on dynamically changing content, such as ads, to ensure that they comply with the sharing user's preferences. If the preferences are stored in a profile, when such dynamic content is being replaced, the server serving the shared webpage may access both the sharing user and the recipient's profile, determine whether the dynamically changing secondary content meets the preferences of both profiles, and then share accordingly.

As described earlier, the sharing user may also select to replace content in a section of the webpage. In this embodiment, when a section is voluntary and can be replaced with replacement content, or a section is selected by the sharing user for replacement, the system may allow secondary content providers, such as advertisers, to bid on replacing selected sections of a webpage with their content. Accordingly, the system may deploy a bidding process where secondary content providers can compete to replace these sections with relevant, recent, trending, and engaging content. Such a bidding process may be designed to ensure that the replacement content a) either aligns with the current content in that space, b) aligns with the overall concept the webpage, or c) is different or does not have the same elements of the content being replaced, because that may be the reason for the replacement, such as to avoid inappropriate content. In this embodiment, secondary content providers may submit bids that include content proposals, pricing offers, and adherence to specific guidelines, such as avoiding certain topics or formats. The system may then evaluate these bids from the secondary content providers based on both content quality and price, selecting the most suitable option to fill the vacant space or use other criteria such as selecting the highest bidder. This approach may be used to keep the content in the section being replaced more relevant, engaging, and of interest to the recipient. The recipient's preferences learned from their profile or browsing history, if provided access to, may also be used in determining the secondary content. When the recipient's preferences are taken into consideration, the server serving the shared webpage may access the recipient's profile, determine whether the dynamically changing secondary content meets the preferences and any restrictions in the recipient's profile, and accordingly provide the secondary content. In some embodiments, although a sharing user may have shared certain content, if the recipient's profile restricts such content, then the system may a) replace it to the recipient's preferences, b) inform the sharing user that such content was not displayed to the sharing user, and/or c) replace the space where the secondary content was to be show as either a blank space or with a watermark indicating that the content is restricted based on the recipient's profile.

At block 103, in one embodiment, the system may generate a URL query string that informs the recipient's browser which sections to render and which to omit or replace. The generated URL with the query string may be transmitted to the recipient device. Once a sharing user selects sections of the webpage they wish to share with a recipient, the system may automatically, without user intervention, generate the query string that reflects the sharing user's preferences. Since the HTML code may have been generated when the author (or system) performed the marking at block 101, the HTML code along with the query string may be used as instructions to the recipient's browser for ensuring that when the recipient selects or launches the URL to the webpage shared by the sharing user, the recipient's browser accesses the HTML code and then uses the query string to determine which sections to render. For example, the HTML code may indicate which sections are marked by the author as required and optional. And of the optional sections, the query string may be used as a guide to determine within the optional sections, which are to be rendered, replaced, or omitted.

The sharing user, in some embodiments, may share the URL with the recipient, such as via email, text message, or chat. The URL may be the URL for the webpage for which sharing user's preferences were reflected in a query string. When the recipient receiving the URL selects, such as by touching or clicking the URL, or selects a related embedded webpage link, the recipient's browser may be pointed or directed to the HTML code, as depicted at block 104. The recipient's browser may read the HTML code, determine how to render sections associated with the HTML code, which is based on instructions in the query string, as described further below, and then render the sections, replace, or omit the section.

In some embodiments, as described above, the system may enable selective sharing of specific sections or portions of the webpage by encoding identifiers of chosen sections within a query string, ensuring that only the relevant content is shared and rendered when accessed by the recipient.

In some embodiments, the system may allow the sharing user to share sections of a webpage by embedding identifiers of those sections within a query string. Such embedding may ensure that only the sections selected for sharing are shared and displayed when the recipient's browser performs the rendering of the webpage. Likewise, sections not to be shared or to be replaced may also be reflected in the query string. For example, a query string may be created as part of the URL. This query string is part of the URL and comes after a question mark (?). For example, “q=query+string” in the URL Https://www.XYZ.com/search?q=query+string, is the query string. The system may set an action in the query string on what is and is not shared by the sharing user. The process, in some embodiments, may include assigning a unique identifier to each section in the webpage. The unique identifier may be based on an HTML attribute. The action, for example, may be embedded in the query string of the URL as follows: Https://www.XYZ.com/?shareSection7=true or Https://www.XYZ.com/?donotshareSection6=true. Such action may be associated with allowing sharing of Section 7 of the webpage and not allow sharing of Section 6, which may be the sharing preferences selected by the sharing user for those sections. Likewise, a query string, https://www.example.com/page?selected=content1+content2, may be used to identify that both content 1 and content 2 are selected for sharing.

When the recipient selects the shared URL with the query string, the recipient's browser, to render the selected sections of the webpage on the recipient's side, may employ client-side JavaScript to process the query string. The script may read the query string, extract the identifiers of the selected sections, such as required or voluntary, shared, hidden, replaced, and dynamically hide, replace, or display the sections of the webpage accordingly. For instance, if the selected sections are content1 and content2, the script may locate elements with the corresponding id or data-share-id values and make them visible while hiding all other sections. As such, only the sections selected for sharing may be rendered in the recipient's browser. Alternatively, server-side processing may be used to achieve the same result by rendering only the selected sections on the server before delivering the HTML content to the recipient.

At block 105, the recipient's browser may perform rendering of the webpage based on the HTML code and instructions from the query strings. In other words, the recipient's browser may render whatever the server hosting the HTML code generates and then for the sections that are voluntary, use the instructions from the query string to determine how to render them. The recipient's browser may read the HTML code and accordingly render sections of the webpage that are permitted for sharing and either hide or replace the sections marked for hiding or replacement. The process of the recipient entering the URL to rendering may include the recipient first selecting the shared URL for the webpage. Once the recipient selects the URL, the recipient's browser may use the URL to obtain the IP address of the webpage by performing a DNS lookup. Once the recipient's browser obtains the IP address of the webpage, the recipient's browser may send an HTTP request to the server hosting the webpage. The server, upon receiving the request from the recipient's browser, may process the request and transmit back to the recipient's browser, an HTTP response containing HTML, CSS, and/or JavaScript files. At this stage, the recipient's browser, such as via a rendering engine associated with the recipient's browser, may start parsing the HTML code and breaking it down into tokens thereby constructing a tree-like structure known as the DOM (Document Object Model), which represents the hierarchical structure of the webpage's elements. The recipient's browser may also parse the CSS files linked to the HTML, creating another tree-like structure called the CSSOM (CSS Object Model), which is related to the layout of the page. Once the recipient's browser constructs the structures for the DOM and CSSOM, it may merge them to create a rendering tree. This rendering tree may represent the visual structure of the webpage and its layout. The recipient's browser may then calculate the exact position and size of each element and paint the pixels on the screen to display the webpage's sections that are shared by the sharing user in accordance with the modified HTML code of the webpage that defines which sections are to be shared. In some embodiments, if the webpage includes JavaScript, the recipient's browser may execute the JavaScript and modify the DOM and CSSOM. Likewise, if the webpage includes JavaScript and the URL provided to the recipient's browser includes a query string that provides information on which section to render, then the recipient's browser may employ the JavaScript to process the query string. To do so, it may perform a process that includes reading the query string, extracting identifiers from the query string, retrieving sections of the webpage, and displaying shared sections, hiding sections not to be displayed, and displaying sections with replaced content that are marked for content replacement, e.g., voluntary.

With respect to rendering, in some embodiments, the sharing user or the system may cause rendering of some content or sections of webpage on the recipient side browser and other content, such as content that may be secondary, irrelevant, not contextually related, or inappropriate, to be transmitted to a secondary device of the recipient, such as their mobile phone, instead of being rendered on their browser. Accordingly, the sharing user or system may set up rules on what can be rendered on the recipient's browser and what sections are to be transmitted to a second device.

At block 106, data analytics may be collected from the recipient and shared with the author and/or the sharing user and likewise data analytics may also be collected from the sharing user and shared with the author. Since data analytics provide valuable insights into how users interact with content, collecting detailed engagement data, such as time spent on specific sections of the webpage that were shared, scrolling behavior, and content interactions like forwarding, saving, or liking, may be beneficial to the author, to determine what part of their content was of interest to the sharing user and the recipient and if the recipient engaged with the content in the section to provide them deeper understanding.

This level of granular data may be used to detect patterns in recipient's behavior, such as which sections are most popular and which ones are not of interest or less engaging, which can be determined by whether the recipient scrolled over the section or completely skipped it. Such granular data may allow the authors to optimize their content to improve user experience and it may also allow the sharing user to better understand their audience and change their sharing preferences. For example, the author may reorganize the page layout, replace underperforming sections, and the sharing user may not share sections skipped and share more of the sections that were engaged with.

This granular data relating to the recipient's engagement with the various shared sections, such as on a section by section basis, may also help webpage authors to get the opportunity to further monetize sections of the webpages that may be skipped over during sharing. As such, the embodiments provide multiple levels of flexibility to all the stakeholders, including browsers that can offer data metrics tools to determine engagement on a section by section level. The embodiments also allow the authors to perform dynamic A/B tests for their webpage by recruiting willing users that may contribute to the dynamic webpage optimization process.

Once the data analytics are obtained, the system may automatically store such data analytics and engagement data for each person the sharing user shared the URL with and use that for future recommendations. For example, if Bob shared certain sections of a webpage with Sally, the engagement data may be stored and next time Bob selects another webpage with sections to share and sections to hide/replace, the system may automatically display Sally's preference to Bob and make recommendations based on what was learned from a previous exchange of webpage sharing between Bob and Sally.

Additionally, recipient's actions that were performed after the recipient engaged with the shared web page may be tracked and captured. For example, if the recipient explored product details or further researched a topic that was in a shared section of the webpage may provide valuable feedback on the effectiveness of the content. Such recipient's actions may be provided to the author or sharing user on a section by section basis. For example, if a recipient actions after the engagement with the page relate to only a section A, B, and C, for a webpage that includes sections A-E, then engagement metrics provided may indicate that the recipient did not engage sections D and E. The engagement metrics may further indicate that recipient browsed products related to the content in section B. In some embodiments, instead of sharing engagement metrics of the webpage as a whole, engagement with a subset of sections that are voluntary may be shared such that the author or sharing user may determine whether the content in voluntary sections needs to be replaced for better engagement.

At block 107, once data/web analytics relating to the recipient's engagement are received at block 106, the data analytics can be used to inform the modification of the existing marking or labels for the sections of the webpage. For example, if a shared section was overlooked or skipped by the recipient, and it previously was marked as mandatory, based on the lack of engagement, the section's label may be changed to voluntary. On the other hand, if a determination is made that a voluntary section was found to be more engaging to the recipient, based on the data analytics received, its label may be changed to mandatory to be shared in the future. Accordingly, the system may in real-time and dynamically modify marks or labels for the sections based on data analytics related to the recipient's engagement.

FIG. 2 is a block diagram of a system for sharing some sections of a webpage, hiding or replacing content of other sections of the webpage, and rendering and tracking user engagement with the shared content, in accordance with some embodiments of the disclosure and FIG. 3 is a block diagram of a user device used for sharing some sections of a webpage, hiding or replacing content of other sections of the webpage, and rendering and tracking user engagement with the shared content, in accordance with some embodiments of the disclosure. FIGS. 2 and 3 also describe example devices, systems, servers, and related hardware that may be used to implement processes, execute user interface operations, and all other steps, functions and functionalities described at least in relation to FIGS. 1, and 4-13. Further, FIGS. 2 and 3 may also be used for allowing an author or a device associated with an author of a webpage to: mark sections of the webpage as required, voluntary, or with another mark that reflects which section is to be shared during a sharing operation, and which section is allowed flexibility of inclusion or exclusion during a sharing operation, and which section is to be replaced with secondary content; modify HTML code based on the author's sharing marks; and generate a URL for the webpage with the modified HTML code that reflects the author's marking of sections. The system and devices of FIGS. 2 and 3 may also be used for allowing the sharing user or a device associated with the sharing user to: select those sections of the webpage which are permitted by the author to be associated with the sharing user's preferences; receive a selection from the sharing user, where the selection may be associated with sharing the selected section, hiding the selected section, not sharing the selected section, or replacing content in the selected section when shared in a sharing operation with a recipient device; upon receiving the selection for a section to include or exclude in the sharing operation, determine whether other sections share attributes with the selected section that exceed an attribute matching threshold, and if so, recommending selections of the other sections with the same selection as that of the selected section or automatically selecting the sections without user intervention; where analyzing of data attributes of the plurality of sections of the webpage; and further generating a query string to reflect the sharing user's shared preferences and to instruct the browser associated with the recipient client device to render a particular section, not render a particular section, or render a particular section with replaced secondary content in accordance with the HTML code and as instructed by the query string instructions. The system and devices of FIGS. 2 and 3 may also be used for allowing the device, such as a website hosting server to: initiate a bidding process to receive bids from secondary content providers for secondary content items that are to replace current content in a section selected for replacement; transmit the generated URL to the recipient client device, receive a selection of or other request to launch the URL; cause the recipient client device to access the modified URL for rendering in accordance with the modified URL; track engagement metrics of the recipient device after the rendering of the section of the webpage in accordance with the modified URL that reflects the sharing preferences of the sharing user; and use the engagement metrics to revise markings or labels for sections of the webpage, utilizing AI and ML algorithms for providing marking recommendations; and perform functions related to all other processes and features described herein.

In some embodiments, one or more parts of, or the entirety of system 200, may be configured as a system implementing various features, processes, functionalities and components of FIGS. 1, and 4-13. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., author's marks, sharing user's marking preferences for each section of the webpage, contextual relationships between sections of the webpage, attributes of each section of the webpage, tables, marks, and recommendations associated with each section, sharing user and recipient engagement metrics and data analytics, HTML code and modified HTML codes query strings, bidding criteria and bidding selections and results, and, AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating to author's marks, sharing user's selection preferences for each section of the webpage, contextual relationships between sections of the webpage, attributes of each section of the webpage, tables, selections, and recommendations associated with each section, sharing user and recipient engagement metrics and data analytics, HTML code and modified HTML codes query strings, bidding criteria and bidding selections and results, and, AI and ML algorithm, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to detecting selection of only a first section, from a plurality of second set of sections, for sharing with the recipient device, the control circuitry 228 automatically associating the remaining sections in the second set of sections of the webpage with either not sharing or sharing with replaced content. In another example, in response to the sharing user selecting a first section of the webpage for inclusion or exclusion in a sharing operation, the control circuitry 228 determining whether other sections share attributes with the selected first section that exceed a threshold, and if so, the control circuitry 228 recommending the other sections that share attributes with the selected first section that exceed the threshold to be selected with same selections as the first section. The control circuitry 228 may also perform steps of processes described in FIGS. 1, 4, 7-9, and 12, including determining whether a section of the webpage is to be included or excluded in a sharing operation with a recipient based on selection of the section by the sharing user.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as data relating to author's marks, sharing user's selections for each section of the webpage, contextual relationships between sections of the webpage, attributes of each section of the webpage, tables, marks, and recommendations associated with each section, sharing user and recipient engagement metrics and data analytics, HTML code, query strings, bidding criteria and bidding selections and results, and, AI and ML algorithms and input from primary devices and secondary devices, such as a mobile phone used for selecting a section of a webpage. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, or any other device, computing equipment, or wireless device, and/or combination of the same capable of suitably determining in response to detecting selection of only a first section, from a plurality of second set of sections, for sharing with the recipient device, automatically associating the remaining sections in the second set of sections of the webpage with either not sharing or sharing with replaced content. In another embodiment, the computing device 218 may in response to the sharing user selecting a first section of the webpage for inclusion or exclusion in a sharing operation, determining whether other sections share attributes with the selected first section that exceed a threshold, and if so, recommending the other sections that share attributes with the selected first section that exceed the threshold to be selected with same sharing selections as the first section.

Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 220 and/or control circuitry 218 is configured for allowing an author or a device associated with an author of a webpage to: mark sections of the webpage as required, voluntary, or with another mark that reflects which section is to be shared during a sharing operation, and which section is allowed flexibility of inclusion or exclusion during a sharing operation, and which section is to be replaced with secondary content; modify HTML code based on the author's sharing marks; and generate a URL for the webpage with the modified HTML code that reflects the author's marking of sections The control circuitry 220 and/or control circuitry 218 may also be used for allowing the sharing user to select those sections of the webpage which are permitted by the author to be marked with the sharing user's preferences, receiving a selection from the sharing user, where the selection may be associated with sharing the selected section, hiding the selected section, not sharing the selected section, or replacing content in the selected section when shared in a sharing operation with a recipient device, upon receiving the selection for a section to include or exclude in the sharing operation, determining whether other sections share attributes with the selected section that exceed an attribute matching threshold, and if so, recommending selection of the other sections with the same selection as that of the marked section, generating a URL that includes a query string that instructs the recipient client device and/or the browser associated with the recipient client device to render a particular section, not render a particular section, or render the particular section with replaced secondary content in accordance with the HTML code with instructions from the query string. The control circuitry 220 and/or control circuitry 218 may also be configured to allow a device, such as a website hosting server to: initiate a bidding process to receive bids from secondary content providers for secondary content items that are to replace current content in a section selected for replacement; transmit the generated URL to the recipient client device; receive a selection of the URL; cause the recipient client device to access the modified URL for rendering in accordance with the modified URL; track engagement metrics of the recipient device after the rendering of the section of the webpage in accordance with the modified URL that reflects the sharing preferences of the sharing user; and use the engagement metrics to revise markings or labels for sections of the webpage, utilizing AI and ML algorithms for providing marking recommendations, and perform functions related to all other processes and features described herein.

Computing device 218 receives a user input 204 at input circuitry 216. For example, computing device 218 may receive data relating to selection of a section, generate a query string that reflects the selection, and transmit the URL with the query string to the recipient's device for rendering the version of the shared webpage.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, Wi-Fi, WiMAX, GSM, UTMS, CDMA, TDMA, 3G, 4G, 4G LTE, 5G, 5G sidelink (5G NRV2X), 6G, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, Wi-Fi, WiMAX, GSM, UTMS, CDMA, TDMA, 3G, 4G, 4G LTE, or other wireless transmission protocols.

Processing circuitry 240 may receive input 204 from input circuitry 216. Processing circuitry 240 may convert or translate the received user input 204 that may be in the form of voice input into a microphone. In some embodiments, input circuitry 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4, 7-9, and 12, respectively.

FIG. 3 is a block diagram of a user device used for sharing some sections of a webpage, hiding or replacing content of other sections of the webpage, and rendering and tracking user engagement with the shared content, in accordance with some embodiments of the disclosure. In an embodiment, the equipment device 300, is the same equipment device 202 of FIG. 2. The equipment device 300 may receive content and data via input/output (I/O) path 302. The I/O path 302 may provide audio content (e.g., voice commands from a sharing user to mark a section of the webpage). The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor). In client-server-based embodiments, the control circuitry 304 may include communications circuitry suitable for allowing an author or a device associated with an author of a webpage to: mark sections of the webpage as required, voluntary, or with another mark that reflects which section is to be shared during a sharing operation, and which section is allowed flexibility of inclusion or exclusion during a sharing operation, and which section is to be replaced with secondary content; modify HTML code based on the author's sharing marks; and generate a URL for the webpage with the modified HTML code that reflects the author's marking of sections. The communications circuitry may also be suitable for allowing the sharing user to select those sections of the webpage which are permitted by the author to be selected with the sharing user's preferences, receiving a selection from the sharing user, where the selection may be associated with sharing the selected section, hiding the selected section, not sharing the selected section, or replacing content in the selected section when shared in a sharing operation with a recipient device, upon receiving the selection for a section to include or exclude in the sharing operation, determining whether other sections share attributes with the selected section that exceed an attribute matching threshold, and if so, recommending selection of the other sections with the same mark as that of the marked section, further generating the HTML code to reflect the sharing user's selected sharing preferences and/or modifying the URL to include a query string that instructs the recipient client device and/or the browser associated with the recipient client device to render a particular section, not render a particular section, or render the particular section with replaced secondary content in accordance with the modified HTML code and/or the query string instructions. The communications circuitry may also be suitable for allowing a device, such as a website hosting server to: initiate a bidding process to receive bids from secondary content providers for secondary content items that are to replace current content in a section selected for replacement; transmit the generated URL to the recipient client device, receive a selection of or other request to launch the URL; cause the recipient client device to access the modified URL for rendering in accordance with the modified URL; track engagement metrics of the recipient device after the rendering of the section of the webpage in accordance with the modified URL that reflects the sharing preferences of the sharing user; and use the engagement metrics to revise markings or labels for sections of the webpage, utilizing AI and ML algorithms for providing marking recommendations; and perform functions related to all other processes and features described herein.

initiating a bidding process to receive bids from secondary content providers for secondary content items that are to replace current content in a section selected for replacement, transmitting the generated URL to the recipient client device, receiving a selection of the URL, and causing the recipient client device to access the modified URL for rendering in accordance with the modified URL, tracking engagement metrics of the recipient device after the rendering of the section of the webpage in accordance with the modified URL that reflects the sharing preferences of the sharing user, and using the engagement metrics to revise selection for sections of the webpage, utilizing AI and ML algorithms for providing selection recommendations, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store various types of content, (e.g., author's marks, sharing user's selection preferences for each section of the webpage, contextual relationships between sections of the webpage, attributes of each section of the webpage, tables, marks, and recommendations associated with each section, sharing user and recipient engagement metrics and data analytics, HTML code and modified HTML codes query strings, bidding criteria and bidding selections and results, and, AI and ML algorithms). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech, such as to select a section of a webpage.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to selecting sections of the webpage, generating HTML code and query strings in accordance with the selections, and instructing rendering of only those sections of the webpage that are selected for sharing, and implementing machine learning (ML) and artificial intelligence (AI) algorithms, and all the functionalities discussed associated with the figures mentioned in this application.

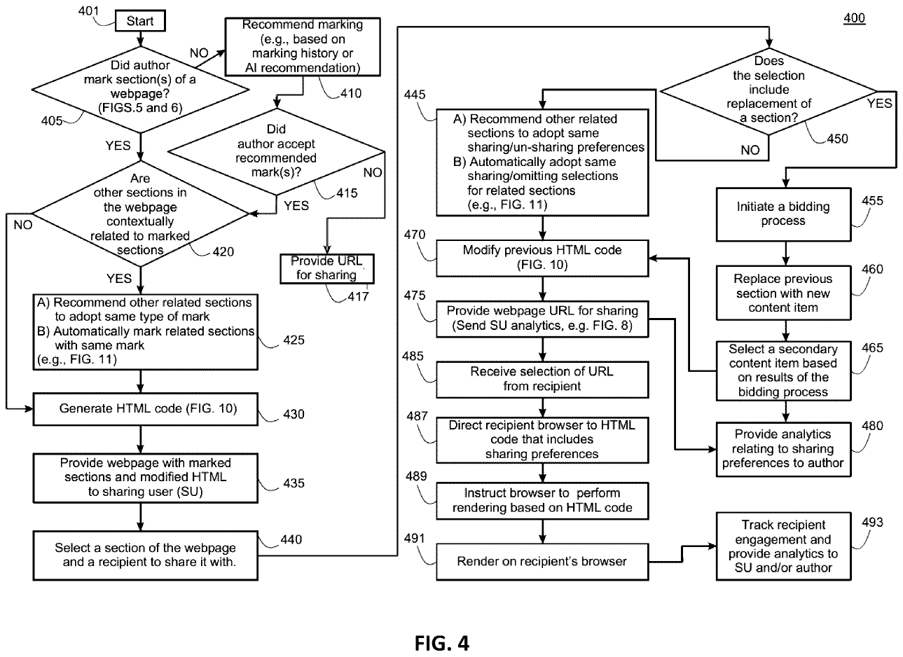

FIG. 4 is a flowchart of a process 400 for sharing some sections of a webpage, hiding or replacing content of other sections of the webpage, and rendering and tracking user engagement with the shared content, in accordance with some embodiments of the disclosure. The process 400 may be implemented, in whole or in part, by systems or devices, such as those shown in FIGS. 2 and 3 or their control circuitry 220 and/or 228. One or more actions of the process 400 may be incorporated into or combined with one or more actions of any other process or embodiments described herein. The process 400 may be saved to a memory or storage (e.g., any one of those depicted in FIGS. 2 and 3) as one or more instructions or routines that may be executed by a corresponding device or system to implement the process 400.

In some embodiments, process 400 may be initiated at block 401. At block 405, a determination may be made whether an author marked a section of the webpage. The author may physically select a section of the webpage or marking using a plurality of methods. In one embodiment, the author may use a computer mouse or touchpad to highlight the desired section. In another embodiment, the author may click on the section or draw a rectangular box around the section. In yet other embodiments, the author may use keyboard shortcuts, such as double-clicking to select a section of the webpage. In another embodiment, the author may identify the section by its location or coordinates on the webpage. In another embodiment, the author may use voice commands or gestures to select the desired section for marking. In yet other embodiments, the system may automatically generate a unique identifier for each section and provide a list or table of all sections and their unique identifier and the author may be able to select a section and mark in the list or table by selecting the unique identifier, such as by clicking on it or using a pull down menu to select each identifier and mark it.

If a determination is made at block 405 that the author has not marked a section, or any section, of the webpage, then the process may move to block 410, where a recommendation may be made to the author to mark a section of the webpage. The recommendation may be based on the system leveraging artificial intelligence or machine learning to analyze the author's marking behavior and history to suggest marking of a certain section of the webpage. For example, if an author historically marked a section that includes certain attributes with a particular tag, such as required or voluntary, then the system may analyze all current sections in the webpage to determine whether there is a section that meets the attributes of what the author has previously marked on the same or another web page. Such analyzing of the data attributes may be automatically performed by the control circuitry or a server without user intervention. In some embodiments, the author may have more than one web page or more than one tab on the web page and the system may be provided access to all the web pages or tabs of a single web page of the author to analyze and determining what marks were made by the author and what were the attributes of those sections that the author marked. Based on such learning, if a section of the webpage meets attributes of a section previously marked by the author on the same or other webpages or tabs, the system may recommend the author to mark them for a current section. To do so, the system may gain authorized access to the account of the author on the host of the webpages, such as GoDaddy or other web page hosting providers.

At block 410, after the recommendation has been made by the system, a determination may be made whether the author accepted the recommendation. If a determination is made that the author did not mark any sections on his/her own and did not accept any marking recommendation at block 410, then without any section having any marks, the system may generate a URL for the website for sharing at block 417. In another embodiment, if a determination is made that the author did not mark any sections on his/her own and did not accept any marking recommendation at block 410, then the system may provide full flexibility to the sharing user to mark any section as desired and the process may move to block 430.

If a determination is made at block 405 that the author has marked a section or if a determination is made at block 410 that the author has accepted a marking recommendation, then the system may determine at block 420, whether there are other sections in the webpage that are contextually related to the marked sections. To make such a recommendation, in some embodiments, the system may analyze the content and context of a section of the webpage that has been marked by the author at blocks 405 or accepted to be marked based on a recommendation at blocks 410 and 415. The analysis may include extracting attributes of the marked section and establishing relationships between these attributes and the marking. For example, if the content on the webpage section matches the heading of the article and the author has marked that section as required, then the attribute may be to match the section to the heading. In another example, if a section is the first section in the webpage, the section that is the largest in terms of content, or a section that discusses topics XYX, and marked with a particular tag, then attributes that reflect the marking and the type of section may be used to generate a relationship. These relationships, in some embodiments, may be represented using data structures. The system may then compare the attributes of the marked section to those of other sections within the webpage to identify similarities. If the similarity exceeds a predefined threshold, the system may determine that the other section is contextually related to the marked section and recommend similar marks for the unmarked section. In some embodiments, such marking may be referred to as conditional marking. For example, in one embodiment, selecting section M may have been marked by the author with a particular mark than and as such recommendation to also mark section P may be recommended based on match of attributes between the sections. Any type of if this then that IFTTT rules may be created for such conditional marking.

If a determination is made at block 420 that there are other sections on the webpage that are contextually related, then at block 425, the system may either recommend same marks for the other sections that are contextually related such that the author may accept the recommendation and mark them, or the system may automatically mark the other contextually related sections. Once the author marks the sections based on the recommendation or it is done so automatically, then the process may move to block 430.

If a determination is made at block 420 that there are no sections in the webpage that are contextually related, then the process may move to block 430.

At block 430, once the author has completed the marking of the sections of the webpage, the system may generate HTML code for the sections, e.g., the webpage in its entirety considering the marked sections. To provide some background, since HTML is the foundation of web pages, it provides the basic structure using elements like headers, paragraphs, links, and images. Likewise, CSS (cascading style sheets) provides structure as it relates to styling and layout of the webpage, while JavaScript adds interactivity. Using HTML, CSS, and JavaScript, the system may generate the HTML code. This HTML code may provide restrictions to the sharing users to determine which sections the author requires the sharing user to share when sharing the webpage and which sections provide the sharing user the flexibility to replace content or hide the section.

At block 435, the system may provide the webpage URL with the marked sections and the generated HTML code that reflects the marks to the sharing user. This may be on a user interface of the sharing user, such as in their browser, upon the sharing user indicating that they wish to share the webpage with a recipient.

At block 440, a determination may be made whether the sharing user (SU) has made a sharing selection and identified a recipient to share it with. The sharing selection, in some embodiments, may be for the sharing user to select a section of the webpage, using any of the following options: share, replace and share, omit, or hide. Although a few examples of selections are described, the embodiments are not so limited and other selections may also be used. For example, a selection that indicates trending content that relates to the section with the trending content to be shared may also be used.

Required marks, in some embodiments, are marks that may be required to share when sharing the URL for the webpage. It may be associated with core or what the author or sharing user may regard as important for that webpage. As its well known, HTML pages include essential tags like DOCTYPE, HTML, and a head tag, which encloses metadata and non-visual elements that don't directly appear on the webpage. These head tags provide information for web browsers and search engines, such as the website title, metadata, and links to external files. Some websites use Meta's Open Graph protocol, which requires four key properties within the <head> section of each webpage: og:title (page title), og:type (content type, e.g., website, article, or book), og:image (preview image URL), and og:url (canonical URL). By incorporating these Open Graph tags, the system can improve the appearance and engagement of web pages on social media platforms. Since not all implementations use Open Graph, such as social media sites for Twitter/X (uses Cards) and Pinterest have other methods, if the website is not geared towards social media, it may not have implemented any of these tags. As such, the system allows the author and sharing user to mark a section of the webpage, such as by the author marking a section with a <req-share> tag, as the default link preview section that a recipient (e.g., the recipient's browser or an app such as Slack) can use to previews the contents of the page.

Voluntary marks, in some embodiments, may relate to the section being flexible in terms of sharing, e.g., the sharing user may share, hide, or replace the content. Marks associated with varying levels of importance may be used to indicate which sections on a level of importance are to be shared. A higher value on the importance scale may recommend sharing, while a lower value may allow more flexibility and make sharing that section voluntary. Some marks may be used for replacing content in that section but may be restricted to what type of content is allowed.

In some embodiments, if the author of the webpage marks a section as required, which indicates that the author wants the section to be included during a share operation, the system may generate a new tag, such as an HTML tag <req-share> for that section. If the sharing user tries to omit that section during the selection process, the sharing user may not be allowed since the author has marked it as required.

In some embodiments, if the author of the webpage marks a section as voluntary, which indicates that the author has provided the flexibility to the sharing user to not share that section, the system may generate a new tag, such as an HTML tag <opt-share> for that section. The author of the page may structure the sections of the page in a way to measure the effectiveness of each section. Anytime, a sharing user may perform the selection or omitting function just prior to the share operation, data may be collected by the HTTP client and sent to the HTTP server as what <vol-share> sections were omitted by the user. In some embodiments, some of that <vol-share> sections may also be saved in a site cookie file to recognize the sharing user preferences, such as in a sharing user's profile.

In some embodiments, the sharing user may manually select sections of the webpage by highlighting, clicking, using voice commands, identifying the section by its location or coordinates, or by using gestures. They may also use voice commands and/or use their gaze to focus on a section, if wearing an extended reality headset and the system may associate such a gaze as selection of the system for a sharing preference and provide a sharing selection menu in their extended reality environment.

Once a sharing selection has been made and a recipient identified at block 440, a determination is made at block 450 whether the sharing selection made is to replace the content in the selections section. If so, then at block 455, the system may initiate a bidding process. In some embodiments, the system may know in advance that a section will become open and as such a bidding process is to be initiated. For example, when an author marks a section as optional and a sharing user selects that section for replacement, the real estate space vacated by the voluntary, replaced, or skipped sections of the page will become opened to further use. As such the system (e.g., HTTP Server) serving the recipient of the page may initiate a process with an Ad Server or a secondary content server to request ads or other secondary content suitable for the recipient. As such, the real time ad bidding process may be initiated and secondary content providers may be invited to share their content (e.g., in the form of a banner/video ad) that can fit into the new spot on the page.

The bidding process may be to receive bids from secondary content providers, such as advertisers, to bid on replacing content in the section that are selections for replacement. The system may solicit bids, or the advertisers may be informed of available bidding opportunities on a platform which alerts them when a bidding opportunity opens up and may bid for their content. The system may select the bid based on content quality, price, and other criteria provided. The system may also select replacing content based on its relevance, engagement factors, trending factors, and recipient's preferences obtained via the recipient profile.

At block 455, in another embodiment, the system may pre-negotiate the potential ad or secondary content placement locations that may open on sections of a page, based on author marking sections of the page as required (<req-share>) versus voluntary(<vol-share>) and/or the sharing user selection of the sections for replacement. Accordingly, the final receiving client (i.e., the recipient's browser) side RTB process may be accelerated which may simplify and reduce re-packaging the secondary content and cut down the latency to allow it to render faster.

Once the content has been selected via the bidding process at block 460, the system at block 465 may replace the content selections for replacement with the new content item at block 460. The system may then, in one embodiment, modify the HTML code again at block 470 with reference to the newly replaced content, and in another embodiment the system may generate a query string that instructs inclusion or exclusion of those sections, as specified by the selections. For example, the query string may include instructions as to which sections are to be rendered, such as as-is, which sections are to be replaced with secondary content and rendered or omitted.

If a determination is made at block 450, that the selection does not include replacement of a section, then at block 445, the system may a) use AI or machine learning to analyze the author's marking history and suggest relevant marks or b) automatically adopt the same sharing and or un-sharing selections from the sharing user's history. For example, the system may use generative AI platforms, such as CoPilot, to preview the webpage its sections and based on already collected profile data of the recipient, as well as the recipient's past browsing patterns, may suggest sections of the webpage that the sharing may want to include during the share operation versus what sections to avoid. Similar suggestions may be provided to the author when sharing it with the sharing user (e.g., based on the sharing user's profile).

If through blocks 455 or 450, the sharing user has selected sections to be shared, the system may then identify those sections of the webpage for sharing. In some embodiments, the system may apply conditional rules that can include or exclude other sections of the webpage based on their contextual similarity with the selected section. For example, another section with similar attributes as the selected section may be recommended for selection with the same selection, e.g., share, omit, replace.

At block 470, once all the sections in the webpage have been analyzed for their contextual similarity with a marked section, in one embodiment, the system may generate HTML code that reflects all the marks of each section of the webpage. The system may also generate a table with the unique identifier and link it to each section and its associated mark such that a user may be able to easily see which marks are associated with what sections. For example, if a sharing has marked sections 1, 5, 7, 12, and 16 with voluntary marks, the table may allow the sharing user to visually see in one screenshot that sections 1, 5, 7, 12, and 16 were marked as voluntary. In another embodiment, the system may generate a query string that reflects the sharing selection which may be then used in conjunction with the HTML code to determine which sections are to be shared, replaced and shared, or omitted.

At block 475, the sharing user may provide or share a URL, such as with a query string, for the webpage with sections selected for sharing with the recipient. If any of the sections of the webpage include an AutoPlay feature, then during the sharing operation, i.e., when the sharing user may provide or share a URL for the webpage, the AutoPlay feature may be turned off for the receiver to reduce the bandwidth that may be wasted on the recipient's HTTP client. In another embodiment, auto-play may be disabled if the sharing user has paused auto-play videos prior to sharing sections that include an auto-play video.

In some embodiments, once the sharing user provides or shares a URL for the webpage, the system may monitor whether the recipient has selected the URL. If the user has not selected the URL and in the meantime the content on the webpage has been changed by the owner/author or has been updated, then a cached version of the page (created at the time of the share) may be served by the HTTP server of the webpage. While this may be a rare condition, in order to be able to implement this, a timestamp may be associated with the query string in the URL during the share operation. As such, the content that existed at the time of the share may still be provided even though the current content has changed.

In other embodiments, if the recipient has selected the shared URL, then an indication of the selection may be provided to the system at 485, and the system may, at block 487, direct recipient's browser to the modified HTML code that includes the sharing preferences of the sharing user. The system may then, at block 489, direct the recipient's browser via the modified HTML to perform rendering based on the HTML code. At block 491, the recipient's browser may read the HTML code and accordingly render sections of the webpage that are permitted for sharing and either hide or replace the sections marked for hiding or replacement.

In some embodiments, after the sharing user has selected various sections on the webpage for sharing, replacement, or omission, the server may generate a query string that instructs inclusion or exclusion of those sections, as specified by the selections. In one embodiment, once the section is excluded, the excluded section may not be made available to the recipient's browser, e.g., the recipient's browser may never see the excluded section.

In some embodiments, once the recipient's browser displays the content of the webpage in accordance with the HTML code and guided by the query string, at block 493, data analytics relating to the recipient's engagement with the content may be tracked and reported to the sharing user and/or the author. Such data analytics may be used to determine level of engagement, especially with sections of the webpage that the sharing user specifically selected, type of engagement, and identify popular and unpopular sections of the webpage, and provide insights into how each section was engaged with by the recipient. For example, a sharing user might want to know if a shared section that was replaced with new content was engaged with by the recipient and if not, then the sharing user may use different content in the future for replacement. If the content was engaged, the sharing user may want to share similar sections in the future. Similar data analytics, as described above, may also be obtained in reference to the sharing user marking sections of the webpage and provided to the author.

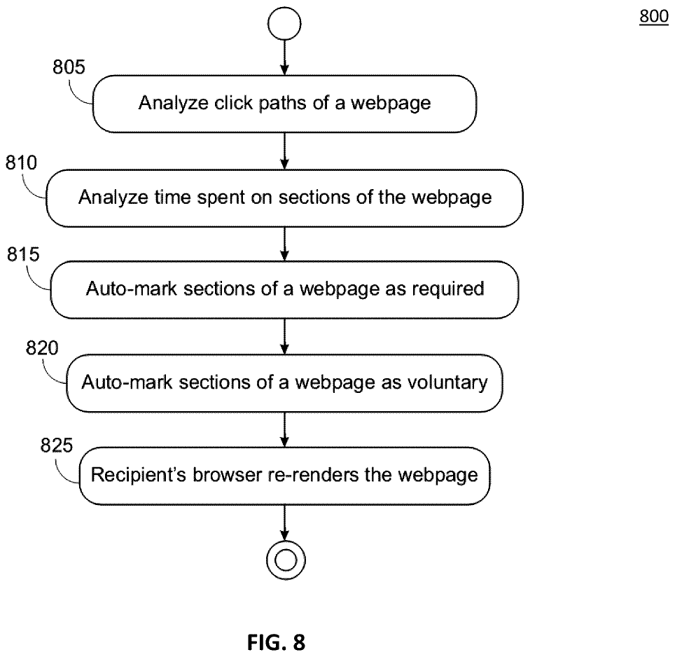

In some embodiments, instead of first having the sharing user select various sections of the webpage, using those selections to generate a query string reflective of the selection, sharing URL with the query string to the recipient's browser, and collecting analytics relating to the recipient viewing the webpage to determine the recipient's level of engagement (e.g., steps as described via blocks 440-493), a reverse process may be used, as further described in FIG. 8. Using this reverse process, the webpage's URL may be shared as is by the sharing user with the recipient. Once the recipient views the webpage, data/web analytics of the recipient relating their engagement with the webpage and various sections of the webpage (as described in block 493) may be collected by the system (e.g., HTTP server). Such data may include data relating to the recipient's click path or time spent on each section of the page. This data may be fed back into the structure of a webpage in a way that sections of the page where the recipient (or other visitors) are spending a lot of time as well as engaging, may be marked with <req-share> whereas sections where there is low engagement, and less time spent will be marked as <vol-share>. In this manner, first the specific recipient, or a sample or user's engagement may be determined, and the section may be selected for sharing based on the recipient's interest and engagement rather than author or sharing user marking or selecting them with their own preferences in hopes of a high level of engagement.

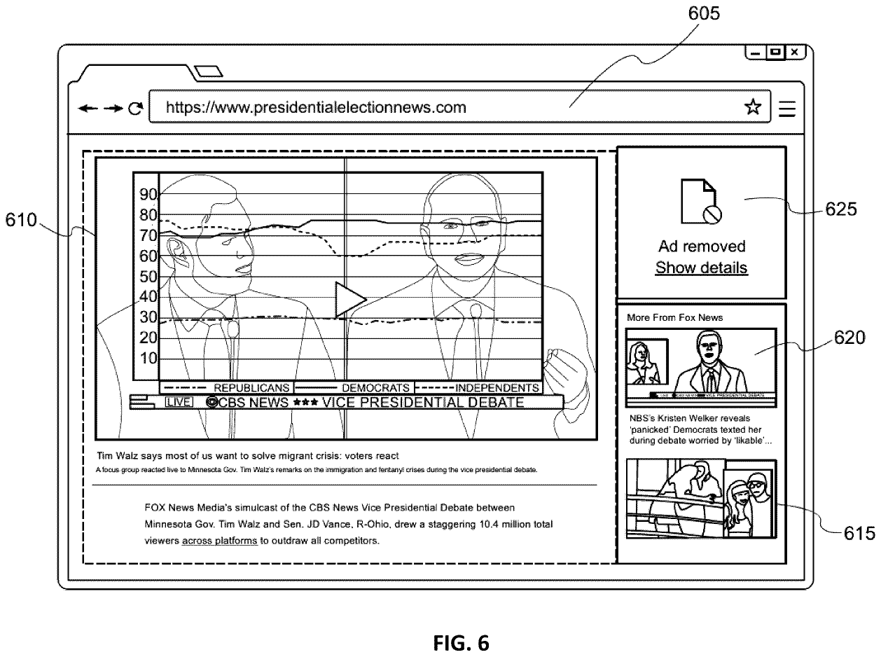

In some embodiments, another approach used by the system may be for the system to allow selective sharing of sections of the webpage by using a query string embedding approach. In this embodiment, the system may leverage query strings to encode identifiers of the selected sections of the webpage. To do so, the system may generate a unique identifier for each section of the webpage, which may then be encoded into the query string and appended to the URL. For example, in FIG. section 515 may have a different unique identifier than section 520. Likewise, in FIG. 6, section 610 may have a different unique identifier than section 615.

When a sharing user (or webpage author) selects a plurality of sections of the webpage for sharing with different sharing preferences, e.g., share, replace content and share, omit section, hide section, the system may generate a list that includes each section, its sharing preference, and a unique identifier associated with the section.

The system may then embed the specific selection for the section in the query string portion of the URL. For example, if section 1 and section 2 have been selected by the sharing user for sharing, the URL with the query string may be as follows: https://www.example.com/page?share=section1+section2. Such a URL, including the encoded query string, may be generated, and shared by the sharing user with the recipient. The query string approach may be implemented using several modern web technologies, offering flexibility based on the structure and complexity of the webpage.

In this approach, the sharing user initiating the share action may be able to select specific sections of a webpage through an interface that allows highlighting or selection of the sections. The identifiers of these selected sections, which may be HTML attributes such as id, may then be captured as described above. Thes URL may contain a query string that lists the identifiers of the chosen sections, allowing for a customized rendering of the webpage when the recipient accesses the link. Upon visiting the link, the system may parse the query string to identify the specific sections to display.

There may be at least two methods for implementing the query string approach described above. In the first method, the system may use id attributes for HTML elements. Using this first method of implementation, each section of the webpage may be given a unique id. The sections having the unique id may be selected with sharing preference to indicate whether they are to be included when sharing, excluded, or replaced. The id may then be embedded into the query string which is part of the shared URL. The browser of the recipient may read the URL and when rendering the page, may do so based on the query string.

In a second method of implementation, the system may use data-* attributes to tag sections of the webpage. Using the second method of implementation may offer flexibility as multiple data-* attributes may be used without the limitations imposed by the id attribute's unique identifier requirement. For example, sections of the webpage may be identified for selection in the following format: <div data-share-id=“section1”>Section Block 1</div>, allowing the query string to reference these custom attributes when selecting content to share. To render the selected sections, such as section block 1 section 1 of the webpage on the recipient side, the system may employ client-side JavaScript to process the query string. The script may read the query string, extract the identifiers of the selected sections, and dynamically hide or display the relevant elements on the page. For example, if the selected sections are section 3 and section 4, the script may locate elements with the corresponding id or data-share-id values. Based on the elements and values, the recipient browser may make sections 3 and 4 visible while hiding all other sections of the webpage thereby ensuring that only the sections intended to be shared by the sharing user are displayed.

In another embodiment, instead of the recipient's browser performing the processing, the processing may be performed at the server-side to achieve the same result by generating only the selected sections on the server before delivering the HTML content to the recipient. Such processing performed at the server side may reduce the amount of data sent and processed by the recipient's browser. In this embodiment, each shareable section may be assigned a class, such as shareable section-1, and the query string may reference these class names to dictate which sections should be displayed. JavaScript may be used to then parse the query string and apply the relevant styles to show or hide the sections based on their class names. This approach may allow the system to group related sections and provides a flexible way of managing multiple selections. For more advanced web applications, the system may integrate with Web Components and the Shadow DOM. In such a scenario, specific sections of the webpage may be encapsulated within custom HTML elements. These Web Components may be isolated from the global DOM structure, allowing for more modular and maintainable code. When the query string is parsed, the system may identify the custom elements, such as <custom-shareable id=“section1”>Section Block 1</custom-shareable>, and either render or hide them as indicated. This approach may benefit large-scale applications where encapsulation and separation of concerns may be required or necessary.

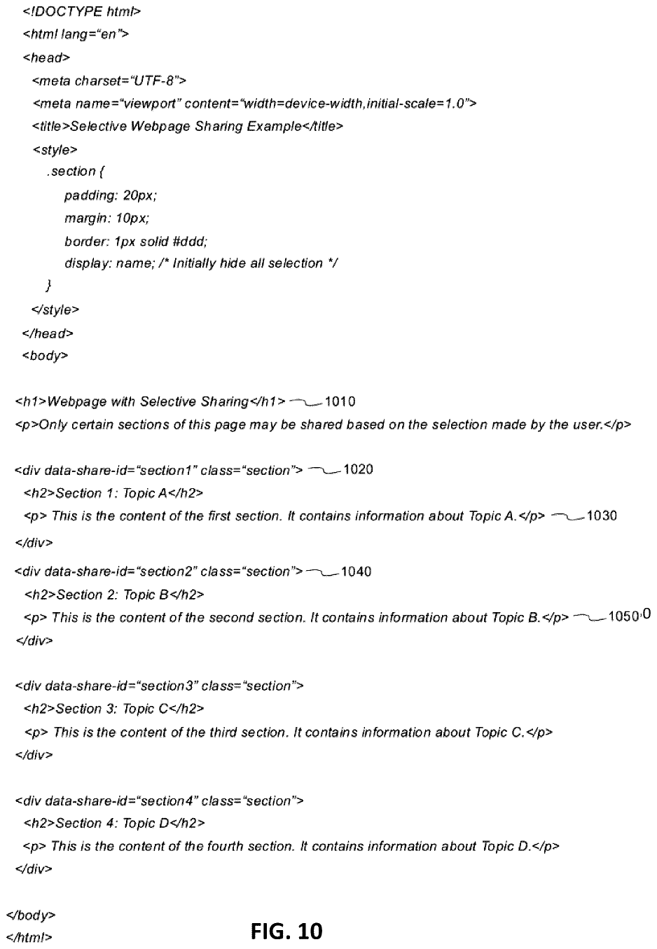

This embodiment may also allow for the integration of modern JavaScript frameworks, such as React, Vue, or Angular. These frameworks may allow for dynamic, state-based rendering of webpage components. In this context, when the selected sections are passed through the query string, the system may update the state of the components responsible for rendering the page, ensuring that only the shared sections are shown. For example, in a React-based system, a component responsible for rendering a section of the webpage may receive the id or class from the query string and may conditionally render the content based on its inclusion in the query string. An example of such id or class based query string may be an HTML markup as depicted in FIG. 10.

Although the embodiment may be processed using a server-side action, e.g., a sharing user side or author side action, to process the query after the “?” in the shared URL, recipient or client-side implementation may also be used that may be consist in taking advantage of HTML bookmarks. For example, a webpage may include a plurality of bookmark marks (e.g., something like “<h1 id=“BOOKMARK01”>content</h1>”) and upon detection that a sharing user is selecting a section of that webpage for sharing, a web browser may select one bookmark amongst the plurality of bookmarks in the page based on the proximity of the bookmark with the shared section of the webpage and append it to the base URL of the shared page. For example, if a sharing user is browsing http://example.com/news and that page include 4 articles associated with a bookmark tag “article-1”, “article-2”, “article-3” and “article-4”, when selecting article 3 for sharing, the browser may generate a shared URL as http://example.com/news#article-3. This implementation may lower the load on the server but offers less granularity as to which sections of the page is rendered or not as what is does is basically sending the recipient user to the shared section of the page while still loading and rendering the rest of the page. This implementation may reduce the server load, however, may offer less granular control over which sections are rendered. In other words, rendering of a specific section may be performed while the entire page is still being loaded and rendered. In some embodiments, which sections of the webpage will be rendered, the order of rendering, and other rendering details may be accessed by a receiving user when they log into a sharing system, their browser, or the webpage using their profile. For example, when a user logs into their Google account, such as by logging into their Gmail, then the webpage that appears via Google Chrome may already have the user's login and profile information since Google may be able to identify the user across all its services (which include Gmail and Google Chrome) and as such may render pages based on the user's profile preferences, such as the user like to see sections relating to home ownership based on their previous searched that were recorded in the user's profile. Accordingly, Google Chrome may prioritize rendering of section of the webpage that includes home ownership content over other sections.

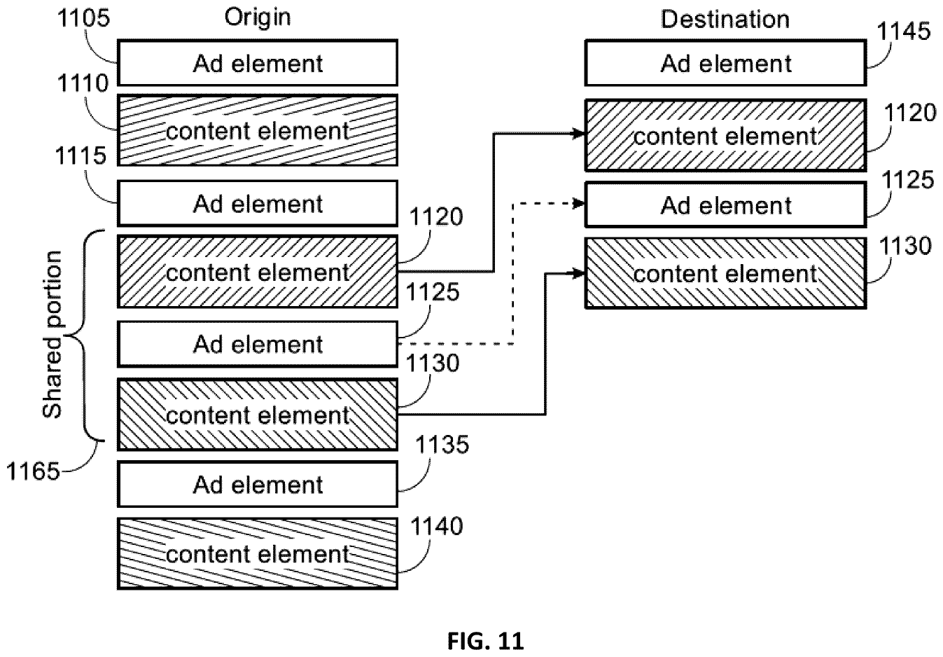

FIG. 5 is an example of webpage having a plurality of sections, in accordance with some embodiments of the disclosure. In some embodiments, the system may automatically divide or partition the webpage into several sections. It may determine these sections such as based on separate HTML elements. For example, a webpage may include a plurality of HTML elements and CSS styles. These HTML elements may be <header>, <nav>, <main>, <aside>, and <footer> or some other elements that provide a structure to the webpage. The HTML elements may also provide insight into the purpose of each element, such as a content element or an ad element, as depicted in FIG. 11. The HTML elements, such as <section> and <div>, may also be used to group related content within a webpage, such that the content may be kept together. Such dividing or partitioning of the webpage into several sections may allow the sharing user to select each section separately for sharing.

These sections, such as those numbered 510 to 545, may be visually distinguished on the user interface when a sharing user clicks on them or enters into a sharing mode. The sharing user, for example, by entering a sharing mode, may then select sharing preferences (such as share, replace, omit, or hide) for one or more webpage sections. In some embodiments, the system may automatically display an option to enter a sharing mode when the user selects any section of the webpage. As described earlier, the selection or identification of sharing preferences may be performed by various methods, such as by highlighting or clicking a section, drawing a boundary around a section, gestural input, gaze tracking in AR/VR, identifying the location or coordinates of the section on the webpage, or touch screen interaction. In some embodiments, the system may provide a table that lists each section, complete with a title or summary, and options for selection from a predefined list of sharing selections or allowing the sharing user to define their own sharing selection.

In some embodiments, once selection is completed by the sharing user, the system may display a table which includes a unique id of each section, a heading or summary of each section, and the related tag. The summary may be automatically generated, for example, using an AI generative system. The system may also automatically analyze all the selected sections in terms of their relevance, relatedness, interest as it relates to recipients preferences, and any recommendations, such as based on page layout or primary content to secondary content ratio, as further described in the description related to FIG. 11 and display such selecting recommendations, unique ids, and summary in a table format. Although a table format is discussed here, the examples are not so limited, and the system may display such information in another format.

In some embodiments, the system may automatically identify the contextual relationships between different sections of a webpage in the table, or other format, as described above such that a sharing user may determine whether to change their selection preferences based on the contextual relationships, e.g., the sharing user may share a section that is related which the sharing user may have selected for not sharing previously. For example, sections 525 and 530, which discuss artificial intelligence, may be identified as highly relevant to the webpage's main topic. Section 515, a link to machine learning, is less directly related but still shares a connection to AI, as machine learning is one of components of an AI system. Similarly, an ad for an AI course, depicted at 535, may be identified as relevant to the webpage as it relates to the main topics in 525 and 530.

In some embodiments, the system may assign a score, such as a relevance score to indicate the degree of relatedness between sections. Accordingly, the system may assign a high score to Sections 525 and 530 since they are highly relevant to the main topic or artificial intelligence. The system may assign a mid-level score to section 515, since it is directed to machine-learning, which may be considered to be indirectly connected to artificial intelligence. With the same methodology, the system may assign a lowest level score, or indicate as irrelevant to the main topic, sections 510, 520, 540, and 545, which relate to ads or other content for beer, pajamas, buying a home or clothing, since they do not relate to artificial intelligence topic of the webpage. Such relatedness, relevance, recipient preferences, layout recommendation may be presented in a table along with the summary.

FIG. 6 is an example of a webpage where sections of the webpage are selected for sharing, replacement, or hiding, in accordance with some embodiments of the disclosure. As described above in FIG. 5, the system may automatically divide or partition the webpage into several sections based on separate HTML elements and CSS styles. Such dividing or partitioning of the webpage into several sections may allow the sharing user to select each section separately. As depicted in FIG. 6, these separate sections may include sections 610-625. As depicted, sections 610 and 620 may relate to the presidential and vice presidential elections, section 615 may relate to trending or celebrity news, and section 625 may be an ad, such as an ad similar to ad 545 in FIG. 5, which displayed a dress worn by a model that is revealing her upper body.

In some embodiments, the system may allow the sharing user to selectively share specific sections of the depicted webpage by selecting desired sections in one of the selection methods described above, e.g., clicking, highlighting, gesturing, and selecting from a table. Once the sharing user makes a sharing selection, the system may modify the JavaScript code to identify the section as a section that is to be shared during a share operation.

In one embodiment, 610, which is depicted with dotted line, illustrates that the sharing user selected the news about the VP debate between Vance and Walz in section 610 however user was not interested in sharing trending or celebrity news and as such did not select section 615 for sharing. The sharing user may be allowed to not select for sharing, section 615, only if the original author has not marked the section as required. If it was marked by the author as required and the sharing user tries to omit that section during the selection process, they will not be allowed to do so. As such, the section may have to be marked as voluntary or some other marking by the author to allow the sharing user the flexibility to not share, hide, or replace the content for the section.

In yet other embodiments, the sharing user may have also found the ad 625 inappropriate for the recipient, which may be the sharing user's daughter, since it displayed a body revealing dress similar to the ad 545 in FIG. 5. As such, the sharing user may select the section to be removed or replaced. All such selections may be stored in a sharing user profile and the system may use the profile for future selection recommendations.

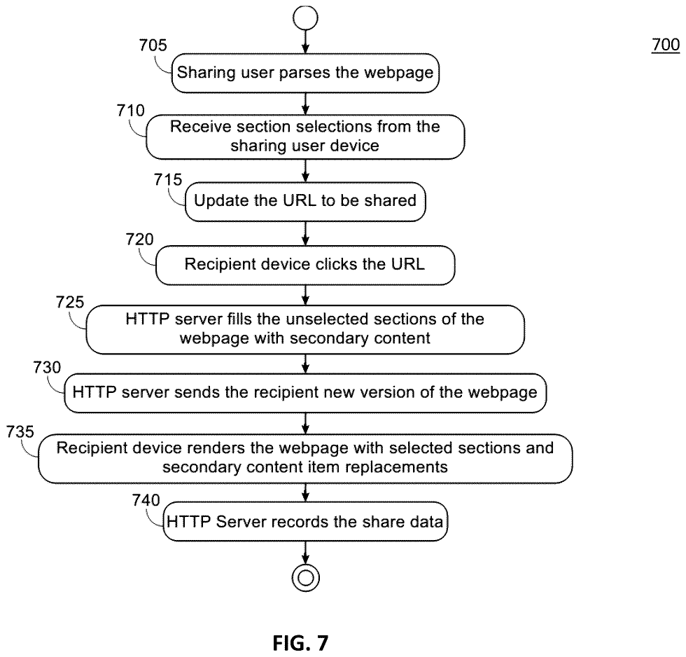

FIG. 7 is a flowchart of a process that implements sharing preferences of sections of the webpage, in accordance with some embodiments of the disclosure. The process 700 may be implemented, in whole or in part, by systems or devices such as those shown in FIGS. 2 and 3. One or more actions of the process 700 may be incorporated into or combined with one or more actions of any other process or embodiments described herein. The process 700 may be saved to a memory or storage (e.g., any one of those depicted in FIGS. 2 and 3) as one or more instructions or routines that may be executed by a corresponding device or system to implement the process 700.

In some embodiments, at block 705, the sharing user may parse through the webpage and select one or more sections of the webpage to include or exclude during a sharing operation with a recipient. Doing so may allow the sharing user flexibility and customization in what the sharing user wants to share with a recipient. If an author of the webpage has initially marked a section as required, then the sharing user may not be provided this flexibility and may be required to share the required section during the share operation. However, if the author of the webpage has marked a section as voluntary, or some other mark allowing sharing flexibility, then the sharing user may select the section for including, excluding, hiding, or replacing during a share operation. In other words, the sharing user may further refine what is to be shared after the author has marked the sections for those sections that the author allows for flexibility in sharing.

The sharing user may parse the webpage and select one or more sections. These sections may also ready be divided or partitioned into a plurality of sections by the system, such as based on HTML elements and CSS styles. These elements, such as <header>, <nav>, <main>, <aside>, <footer>, or some other element, may provide structural information about the webpage and the CSS styles may provide design and layout information for the sections and webpage. The sharing user may be able to select any of such sections, such as by highlighting or clicking a section, drawing a boundary around a section, gestural input, gaze tracking in AR/VR, touch screen interaction, or by selecting the section from a table provided.

The system may perform any one of two embodiments to generate the link to the webpage for which a sharing user has selected sections for sharing, replacing, or omitting. Although two embodiments are discussed below for sake of clarity and explanation, the embodiments are not so limited and other methods, including other HTML and JavaScript based methods, may also be used to identify which sections have been selected for inclusion or exclusion by a sharing user for a sharing operation with a recipient.

In one of the two embodiments, once a sharing user selects sections of the webpage they wish to share with a recipient, the system may automatically, without user intervention, modify the HTML code to reflect the sharing user's sharing preferences. This HTML modification may serve as instructions to the recipient's browser ensuring that when the recipient selects the URL to the webpage shared by the sharing user, the recipient's browser renders the webpage according to the sharing user's sharing preferences that are embedded in the modified HTML code. By modifying the HTML code, the system may control which sections of the webpage are visible to the recipient and which are hidden or replaced.

In a second of the two embodiments, the system may allow the sharing user to share sections of a webpage by embedding identifiers of those sections within a query string. Such embedding may ensure that only the sections selected for sharing are shared and displayed when the recipient's browser performs the rendering of the webpage. Likewise, sections not to be shared or to be replaced may also be reflected in the query string. For example, a query string may be created as part of the URL. This query string is part of the URL and comes after a question mark (?). For example, “q=query+string” in the URL Https://www.XYZ.com/search?q=query+string, is the query string. The system may set an action in the query string on what is and is not shared by the sharing user. The process, in some embodiments, may include assigning a unique identifier to each section in the webpage. The unique identifier may be based on an HTML attribute. The action, for example, may be embedded in the query string of the URL as follows: Https://www.XYZ.com/?shareSection7=true or Https://www.XYZ.com/?donotshareSection6=true. Such action may be associated with allowing sharing of Section 7 of the webpage and not allow sharing of Section 6, which may be selected as such by the sharing user for those sections. Likewise, a query string, https://www.example.com/page?selected=content1+content2, may be used to identify that both content 1 and content 2 are selected for sharing.

When the recipient selects the shared URL with the query string, the recipient's browser, to render the selected sections of the webpage on the recipient's side, may employ client-side JavaScript to process the query string. The script may read the query string, extract the identifiers of the selected sections, such as required or voluntary, shared, hidden, replaced, and dynamically hide, replace, or display the sections of the webpage accordingly. For instance, if the selected sections are content1 and content2, the script may locate elements with the corresponding id or data-share-id values and make them visible while hiding all other sections. As such, only the sections selected for sharing may be rendered in the recipient's browser. Alternatively, server-side processing may be used to achieve the same result by rendering only the selected sections on the server before delivering the HTML content to the recipient.

At block 720, once the URL link is shared, the recipient device may click the shared URL link. At this stage, at block 725, the HTTP server may fill the unselected parts of the webpage with secondary content. In some embodiments, the system may initiate a bidding process to receive secondary content that is to be used to replace content that currently exists in a section marked as voluntary or marked to be replaced. The bidding process may allow secondary content providers to submit bids for sharing their content (e.g., in the form of a banner/video ad) that can fit into the section being replaced on the webpage. The system may solicit bids, or the advertisers may be informed of available bidding opportunities on a platform which alerts them when a bidding opportunity opens up and may bid for their content. The system may select the bid based on content quality, price, and other criteria provided. The system may also select replacing content based on its relevance, engagement factors, trending factors, and recipient's preferences obtained via the recipient profile. Once the content has been selected via the bidding process, the HTTP server may fill the unselected parts of the webpage, sections marked as voluntary, or sections marked with replacement, with secondary content selected via the bidding process. In some embodiments, the system may include its own library of content and may select from the library instead of via the bidding process.

At block 730, the HTTP server may send the recipient device and/or a browser associated with the recipient device, a new version of the webpage. This new version may include sections of the webpage based on the sharing user's sharing selections, e.g., share, replace, omit, and hide. The new webpage may also factor in relatedness and relevance of the sections, recipient's preferences, and layout, to make any adjustments to the new webpage prior to sharing. Further discussion on applying factors of relatedness and relevance of the sections, recipient's preferences, and layout, to make any adjustments is described in FIG. 11.

At block 735, the recipient device and/or its associated browser may render the webpage with selected sections and secondary content replacements.

At block 740, the HTTP server may record the share date in a profile for future use. The servers described herein for author's side, sharing user's side, and receipt side, may be same or different servers. For example, in some embodiments, a single HTTP server may perform both sharing user and recipient side operation while in other embodiments, sharing user may utilize a different HTTP server than the recipient side.

FIG. 8 is a flowchart of a reverse process that uses user engagement analytics to select sections of a webpage, in accordance with some embodiments of the disclosure. The process 800 may be implemented, in whole or in part, by systems or devices such as those shown in FIGS. 2 and 3. One or more actions of the process 800 may be incorporated into or combined with one or more actions of any other process or embodiments described herein. The process 800 may be saved to a memory or storage (e.g., any one of those depicted in FIGS. 2 and 3) as one or more instructions or routines that may be executed by a corresponding device or system to implement the process 800.

The reverse process 800, in some embodiments, may allow the system to first determine user engagement with content on the webpage and use such engagement data to then select the sections accordingly rather than first selecting the sections and then determining user engagement. To do so, in some embodiments, process 800, at block 805, may analyze click paths of a webpage. To analyze the click paths, the system uses a combination of web analytics tools that can track user interactions, such as clicks on links, buttons, or other elements. The system may be able to obtain insights into user behavior, identify navigation of a mouse on a website, determine popular content areas of interest to recipients, determine which sections are skipped etc., The system may also use heatmaps to visually determine the direction and navigation of the user's mouse on the webpage.

At block 810, the system may analyze time spent on a section of the webpage using the tracking analytics and other web analytics tools described above. If a recipient has spent more time on one section than another, the system may automatically capture such time spent and use it for recommendations or auto-tagging. Such engagement metrics, such as based on time spent, across the webpage and various sections of the webpage may be collected by the system (e.g., HTTP server) and stored in a recipient profile.

At block 815, once the recipient time spent is obtained via the data/web analytics, the system may auto-select section so the webpage as required (e.g., with a tag such as <req-share>), such as for sections for which a determination is made that the particular recipient, or a plurality of other users with whom the webpage is shared, have spent a higher amount on time on the section.

At block 815, once the recipient time spent is obtained via the data/web analytics, the system may auto-select section so the webpage as voluntary (e.g., with a tag such as <vol-share>), such as for sections for which a determination is made that the particular recipient, or a plurality of other users with whom the webpage is shared, have spent a lesser, or least, amount on time on the section.

At block 825, the recipient's browser may re-render the webpage in accordance with the auto-selection performed at blocks 815 and 820. In some embodiments, the sharing user or the system may cause rendering of some content or sections of a webpage on the recipient side browser and other content, such as content that may be secondary, irrelevant, not contextually related, or inappropriate, to be transmitted to a secondary device of the recipient, such as their mobile phone, instead of being rendered on their browser. Accordingly, the sharing user or system may set up rules on what can be rendered on the recipient's browser and what sections are to be transmitted to a second device.

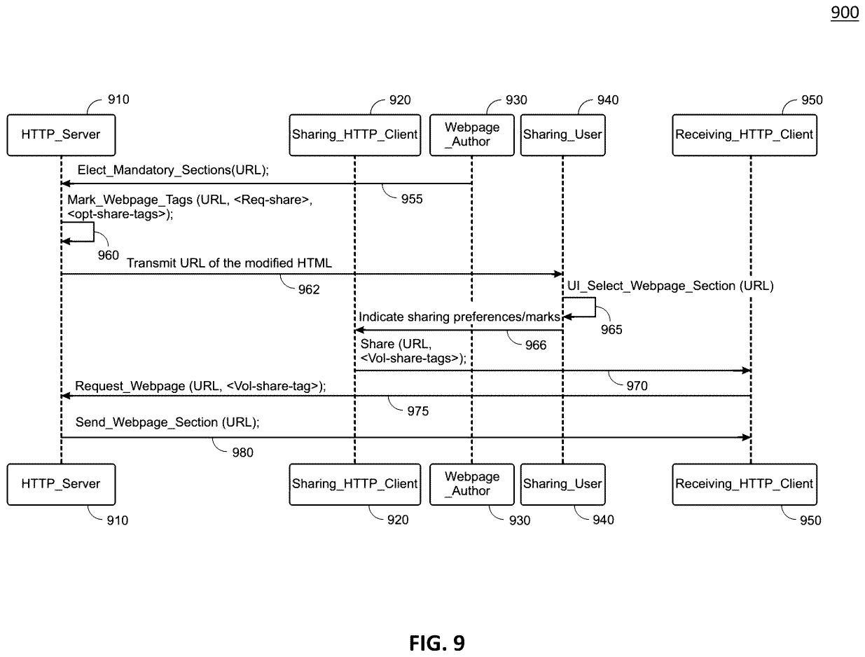

FIG. 9 is a communication process between components of the system to implement sharing preferences for sections of webpage, in accordance with some embodiments of the disclosure. The process 900 may be implemented, in whole or in part, by systems or devices such as those shown in FIGS. 2 and 3. One or more actions of the process 900 may be incorporated into or combined with one or more actions of any other process or embodiments described herein. The process 900 may be saved to a memory or storage (e.g., any one of those depicted in FIGS. 2 and 3) as one or more instructions or routines that may be executed by a corresponding device or system to implement the process 900.

In some embodiments, the communications between an HTTP server 910, a sharing HTTP client 920, a page author 930, a sharing user 940, and a receiving HTTP client 950 are depicted. Although a different HTTP server 9:10, sharing HTTP client 920, and receiving HTTP client 950 is depicted, all the operations may be performed by a single server or multiple servers. For example, the HTTP server may provide operations both for the author and sharing user as well as the receiving recipient.

In some embodiments, a page author may markup one or more sections of the web page with a tag. The author may mark the section independently or do so based on a suggestion from the system leveraging an AI system. The mark used may be required, voluntary, or some other mark indicating a varying level of importance for each section of the webpage, such as on a scale of importance from 1-10 or some other denomination. Marks may also be used to pre-define and fix certain sections of the webpage for sharing and leaving other sections with more flexibility for the author to provide the sharing user the flexibility to select what they desire to share with a recipient. Conditional rules may also be applied when the author or the system is marking sections of the webpage with marks, for example, the conditional rules may direct inclusion or exclusion of certain sections depending on their contextual relationship to other sections.

In one embodiment, as depicted at 955, the page author 930 may elect or request to mark a section of the webpage as required. The request to mark as required may be communicated to the HTTP server 910 at 955.

At 960, the HTTP server 910 may mark the section as a required share section, based on the page author 930's request, and mark all other sections on the webpage as voluntary share sections. This is assuming that only one section was requested to be marked as required by the author, however, the author may request several sections to be marked as required. The HTTP server 910 may then modify the HTML code to reflect the marked sections.

At 962, the HTTP server 910 may transmit a URL for the HTML code with a query string that reflects the marking. The sharing user 940 receiving the HTML code may then select which sections from the voluntary sections to include or exclude in a share operation. If the section is marked as required by the author, such as at 955, then the sharing user may be prevented from omitting or excluding that section in a sharing operation. However, if the section is marked as voluntary, then the sharing user 940 may select the section for sharing, replacement, or hiding during the sharing operation. Such a selection may be performed at 965.

Once the sharing user 940 has selected the sections of the webpage, the selections may be provided at 966 to the sharing HTTP client 920. This may be the client or server that is on the sharing side that generates the URL with the query strings, and performs other sharing operations. In some embodiments, the sharing HTTP client 920 and the HTTP server 910 may be the same device.

The HTTP client 920, at 970, may then identify the sections as voluntary based on the sharing user's selections and then share a modified URL with the receiving HTTP client 950. In some embodiments, the modified URL may include a query string that is indicative of which sections to render and which sections to hide or replace.

At 975, the receiving HTTP client 950 may request a page from the HTTP server 910 upon selection of the URL, such as by the recipient. The HTTP client 950 may be a recipient side browser or device. In some embodiments, it may be the same device as the HTTP server 910.

At 980, the HTTP server 910 receiving the request for the page from the receiving HTTP client 950 may then send the page with the sections selected for inclusion or exclusion to the HTTP receiving client. The receiving HTTP client 950 may then render the page in accordance with the modified HTML and/or instructions in the query string received from the HTTP server.

FIG. 10 is an example of HTML markup for rendering sections of a webpage based on marked sharing preferences, in accordance with some embodiments of the disclosure. In this example, selective sharing may be implemented where a sharing user may have identified sections 1-4 to be shared with the recipient and other sections of the webpage to be excluded from being shared. In this example, when the sharing user makes such a sharing selection, the HTML code may be modified to indicate the sharing user's preferences. As indicated at 1010, the HTML code may indicate that the webpage includes selective sharing. At 1020 the HTML code may indicate that Section 1 is to be shared. At 1030, the HTML code may also include additional details, such as topic or content of the section that is to be shared, e.g., topic of section 1. Likewise, the HTML code may indicate that section 2 is also to be shared with the recipient. The HTML code may also provide the content of Section 2 at 1050. In addition, what is depicted in this particular HTML example, the HTML code may provide additional details regarding each section that is to be shared and or excluded. For example, for sections to be shared, the HTML code may provide a title, a heading, location of the section, coordinates of the section, content in the section, and even a summary relating to this action. Although this particular example describes sharing, other operations, such as replacing content, hiding content, may also be indicated in the HTML code.

FIG. 11 is an example of managing shared sections and sections with secondary content for enhancing webpage user and engagement experience, in accordance with some embodiments of the disclosure.

In some embodiments, when a sharing user shares one or more sections of a webpage based on their sharing preferences, the system may determine the impact on the recipient's experience based on the sharing experiences. The impact determined may be to assess whether irrelevant or excessive secondary content, such as ads, are being shared and if so conclude that such a sharing would take away from the overall user experience of the recipient. For example, a webpage with too many ads becomes distracting from the main content and the recipient may lose interest.

In order to manage recipient user experience, the system may automatically perform user experience assessment and automatically adjust (or suggest to the sharing user to adjust) the sharing preferences, e.g., selection of the sections of the webpage, such that relevant content that balances the main content with secondary content is presented. Such adjustments also include using various layouts that the system may determine to make the overall website more appealing and engaging to the recipient.

In one embodiment, the system may use relatedness as a factor for enhancing the recipient user experience. For example, if a sharing user originally selects content elements 1110, 1120, 1130, and 1140 and secondary elements 1105, 1115, 1125, and 1135 for sharing with the recipient, the system may automatically perform a relatedness analysis between the shared sections. As part of the relatedness analysis, the system may obtain attributes of each of the sections selected for sharing and compare attributes between the sections to determine which sections are related to which other sections. The system may also generate a relatedness table, such as the table provided in FIG. 13, and display it to the sharing user. Once relatedness analysis is completed, the system may automatically select those content elements and ad elements that are related to each other. For example, if content element 1120 and 1130 are related to each other it may select both of them for sharing. Likewise, if a determination is made that ad element 1125 is related to the content elements 1120 and 1130 based on relatedness of attributes between them, then the system may select ad element 1125 for sharing. As such, the final destination may only include content elements and ad elements that are related to each other, such as content element 1120, 1130, and ad element 1125. The system may also invoke artificial intelligence to determine relevance between the content elements and add elements.

In another embodiment, the system may use relevance as a factor for enhancing the recipient user experience. For example, if a sharing user originally selects content elements 1110, 1120, 1130, and 1140 and secondary elements 1105, 1115, 1125, and 1135 for sharing with the recipient, the system may automatically perform a relevance analysis between the shared sections. As part of the relevance analysis, the system may determine, such as by leveraging artificial intelligence, the context and core concepts of the webpage. For example, the context of the webpage may be related to real estate or discussing the benefits of eating healthy. The system may also generate a relevance table that may depict how a particular section is related to the context or core concepts of the webpage. The system may also generate summaries describing such relevance relationships between the particular section to the context or core concepts of the webpage. Once relevance analysis is completed, the system may automatically tag those content elements and ad elements that are relevant to the context of the webpage or core concepts of the webpage for sharing.

In another embodiment, the system may consider the recipient's preferences, as a factor, to improve or enhance the recipient user's experience. For example, if a sharing user originally selects content elements 1110, 1120, 1130, and 1140 and secondary elements 1105, 1115, 1125, and 1135 for sharing with the recipient, the system may automatically determine the recipient's preferences, such as by accessing the recipient's profile, to determine what type of secondary objects to display to the recipient. In this embodiment, the system may dynamically replace specific content sections that are voluntary and selected for replacement with a targeted secondary content item, such as a targeted ad that is based on the recipient's preferences. To select such a targeted ad for replacement, the system may analyze the recipient's profile consumption history, or browsing history, if authorized access to it is provided, and based on the analysis may identify their preferences for products and services. Accordingly, the system may set a criterion to the bidding vendors in a bidding platform to provide an as that meets the criteria, e.g., the recipient's preferences. The system may then select an ad that is tailored to align with the recipient's interests, and which would make the webpage more engaging for the recipient. Such personalization may increase the recipient's user experience and interaction with the secondary content items, e.g., ads. The system may perform the same analysis as selecting and displaying primary content of the website and not just the secondary content items. In some embodiments, the system may also fetch a new ad that was not selected originally in the stack of 1105-1140 by the sharing user for it to be displayed to the recipient, such as ad element 1145, if that would be aligned with the recipient's interest and make the page layout more appealing and engaging.

In another embodiment, the system may use page layout and primary content to secondary content ratio on the webpage as factors for enhancing the recipient user experience. For example, if a sharing user originally selects content elements 1110, 1120, 1130, and 1140 and secondary elements 1105, 1115, 1125, and 1135 for sharing with the recipient, the system may automatically perform a webpage layout and/or primary content to secondary content ratio analysis. This analysis may include comparing the number, size, and location of secondary content, e.g., ads, in comparison to the primary content. For example, an author or system may want to maintain a 70/3, 60/40, or some other ratio of primary or substantive content to secondary content ratio on the webpage such that the ads don't overwhelm a viewer. The system may also take guidance from an artificial engine to determine the ratios. If the analysis conducted by the system determines that the original selection of the content, e.g., blocks 1105-1140, result in a ration that exceeds a system recommendation or author preference, then the system may automatically select again all the content and ad elements considering any of the factors above (e.g., recipient preferences, relevance, or relatedness). The system may also present another selection recommendation to the sharing user and implement another selection of the original content and ad elements upon approval by the sharing user. Such recommendations may be displayed to the sharing user in a table format or may be highlighted on a section by section basis on the sharing user's user interface, e.g., green highlight for sections to share and some other color for sections to remove or not share with the recipient.

Although relatedness, relevance, recipient's preferences, and page layout, have been described above as factors used to provide additional selection recommendations, the embodiments are not so limited and other factors, such as trending content, using previously used content, or not using previously used content to keep content fresh, content from only approved sources, and other factors may also be used.

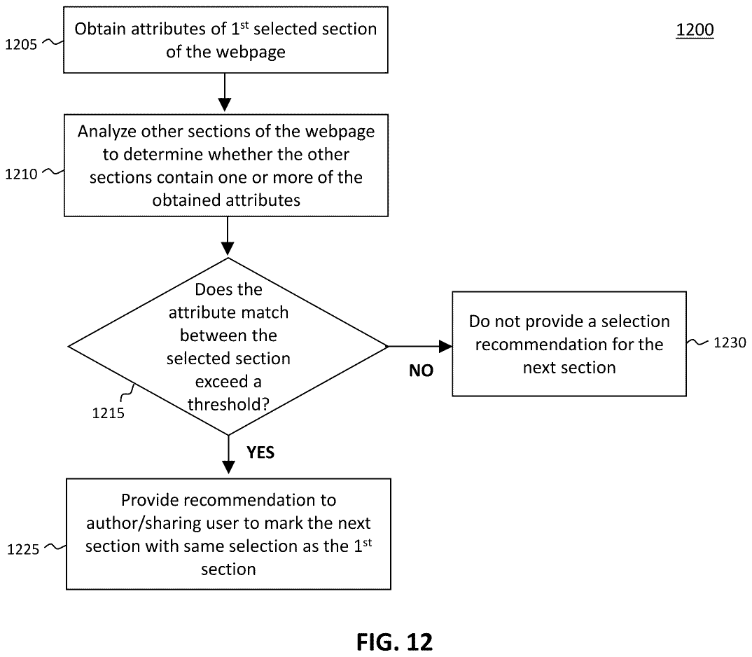

FIG. 12 is a flowchart of a process to recommend related sections on a webpage for marking, in accordance with some embodiments of the disclosure. The process 1200 may be implemented, in whole or in part, by systems or devices such as those shown in FIGS. 2 and 3. One or more actions of the process 1200 may be incorporated into or combined with one or more actions of any other process or embodiments described herein. The process 1200 may be saved to a memory or storage (e.g., any one of those depicted in FIGS. 2 and 3) as one or more instructions or routines that may be executed by a corresponding device or system to implement the process 1200.

In some embodiments, at block 1205, once a section, such as 1^{st} section, has been selected, such as with a selection to share with the recipient, the system may obtain attributes of the 1^{st} section. The attribute may be certain keywords, context, genre, topic, image or anything else reflective of the content in the section.

The system may then analyze the attributes and context of the 1^{st} section at block 1210 to determine whether the other section in the webpage contains one or more of the obtained attributes.

At block 1215, the system may determine if the attribute match between the selected section and another section in the webpage exceeds a threshold. Threshold may be predetermined by the sharing user or the system automatically. The threshold may be having one or more attributes match between the selected section and another section in the webpage. In another embodiment, the threshold may be for the other section in the web page to have at least a certain percentage or certain number of attributes that are to be matched with the selected section for the system to determine that the another section is relevant, related, or similar in attributes to the selected section. For example, in FIG. 6, attributes of section 610 may match the attributes of section 620 to a higher degree and as such exceed the threshold since both sections are directed to news relating to the vice presidential debate. In another embodiment as depicted in FIG. 5, sections 525, 530, and 535 may exceed the threshold number of attributes to determine a match between all the three sections since they all relate to artificial intelligence. However, sections 520, 510, 540 may not have matching attributes since they do not relate to the topic of artificial intelligence or at least do not have attributes that exceed the threshold. However, Sections 510, 520, and 540 may not have the same attributes, or at least not enough matching attributes to exceed the threshold number of attributes since they do not pertain to artificial intelligence.

If a determination is made at block 1215 that attributes between a selected section and another section in the web page do not exceed the threshold, then at block 1230 the system may not provide a selection recommendation for that other section.

If a determination is made at block 1215 that attributes between a selected section and another section in the web page do exceed the threshold, then at block 1225 the system may provide a selected recommendation for that other section for sharing user's approval or may auto-select the other section as indicated blocks 815 and 820 of FIG. 8. In one example where such a recommendation is provided, if a sharing user selected section B for sharing, it may trigger a recommendation to also select sharing of section A since it may be contextually related to section B. Likewise, selection of section P for exclusion from sharing may trigger a recommendation to also select section Q for exclusion since it may be contextually related to section P.

FIG. 13 is an example of a table of relatedness or relationships between sections of a webpage, in accordance with some embodiments of the disclosure. In this example, section 11 1310 may include active attributes A, C, K, and. The system may automatically perform a relationship query based on the attributes of Section 1 to determine if any other sections have similar attributes. Based on the query on a section by section basis, the system may determine that Section 1 is related to sections 2 and 3, where Section 2 has 1 matching attribute with Section 1 and Section 3 has two matching attributes with Section 1. In this example, if the threshold as described in FIG. 12 is set at greater than one attribute, then Section 3 may be determined to be a matching section to Section 1 since it includes two matching attributes. As such a recommendation may be made for selecting Section 3 with the same selection as that of section 1.

Likewise, attributes of Section 2 may also be determined to be attributes A, R, U, Z. The system may then use such attributes A, R, U, Z to query other sections and determine if attributes of other sections match attributes of Section 2. Based on the query, a determination may be made that sections 1 and 4 include similar attributes as that of Section 2. A further determination may indicate that section 1 only includes 1 attribute that matches with section 2 whereas section 4 includes 3 attributes that match with section 2.

Depending on the setting of the threshold, the system may then make recommendations whether to select section 1 or section 4 with the same selection as that of Section 2. For example, if the threshold was set at 2, then only sections that have more than 2 attribute matching may be determined to match section 1.

In the embodiments discussed above, the term automatically relates to performing an action performed by the system or control circuitry 220 and/or 228 without user intervention.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

In some embodiments, the processes discussed above, such as in FIGS. 1, 4, 7-9, and 12, have been described in a particular order or sequence. However, the embodiments are not so limited any other order or sequence, or repetition of steps, are also contemplated within the embodiments.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
hosting at a server, a webpage having a plurality of sections that include a first section and a second section, wherein the first section is to be included in a sharing operation of a shared webpage version of the webpage, and the second section is permitted to be included, omitted, or replaced in the sharing operation of the shared webpage;
receiving, by the server from a sharing client device, instructions to share the second section;
generating, by the server, a URL for the shared webpage that indicates the second section;
receiving, from a receiving client device, a request based on the generated URL for the shared webpage; and
transmitting, in response to the received request, data for the receiving client device to render the shared webpage including the first section and the second section.

2. The method of claim 1, wherein the generated URL is associated with HTML code that identifies which sections of the webpage are to be included in a sharing operation of the shared webpage, wherein the HTML code indicates that the first section and the second section are to be included in a sharing operation of the shared webpage

3. The method of claim 1, wherein the generated URL includes a query string associated with the second section and not the first section.

4. The method of claim 1, further comprising:
analyzing data attributes of the plurality of sections of the webpage; and
identifying, based on the analyzed data attributes, the first section as required to be included in the sharing operation of the shared webpage, and identifying the second section as voluntary to be included, omitted, or replaced in the sharing operation of the shared webpage.

5. (canceled)

6. The method of claim 4, further comprising:
determining, by the server, a primary context of the webpage based on the analyzing data attributes of the plurality of sections of the webpage; and
identifying each section, from the plurality of sections of the webpage, that relates to the determined primary context of the webpage with a first mark that requires inclusion of the section in the sharing operation of the shared webpage.

7. The method of claim 4, further comprising:
determining, by the server, a primary context of the webpage based on the analyzing data attributes of the plurality of sections of the webpage; and
identifying each section, from the plurality of sections of the webpage, that does not relate to the determined primary context of the webpage with a second mark that permits inclusion, omission, or replacement of the section in the sharing operation of the shared webpage.

8. The method of claim 1, further comprising:
analyzing consumption history associated with the sharing client device;
detecting a pattern based on the analyzed consumption history; and
selecting, in response to the detected pattern, the first section of the webpage as required to be included in the shared webpage.

9-13. (canceled)

14. The method of claim 1, wherein the transmitted data for the receiving client device to render the shared webpage is the first section and the second section.

15. (canceled)

16. The method of claim 1, wherein rendering of the webpage in a browser associated with the receiving client device is performed in accordance with HTML code generated for the shared webpage that indicates sharing of the first and second sections of the shared webpage.

17. The method of claim 1, further comprising, receiving, by the server, a selection for the second section, wherein the selection relates to replacing current content in the second section with secondary content.

18. (canceled)

19. The method of claim 17, further comprising:
performing a real-time bidding process to receive bids from one or more third-parties for replacing the current content in the second section with the secondary content; and
selecting a secondary content item from the one or more third-parties based on bids received from the third-parties in real-time.

20. The method of claim 1, wherein the generated URL includes a query string, wherein the query string includes information on which sections, from the plurality of sections, of the webpage are to be rendered by the receiving client device.

21. A system comprising:
communications circuitry configured to access a webpage; and
control circuitry configured to host a webpage having a plurality of sections that include a first section and a second section, wherein the first section is to be included in a sharing operation of a shared webpage version of the webpage, and the second section is permitted to be included, omitted, or replaced in the sharing operation of the shared webpage;
receive from a sharing client device, instructions to share the second section;
generate a URL for the shared webpage that indicates the second section;
receive, from a receiving client device, a request based on the generated URL for the shared webpage; and
transmit, in response to the received request, data for the receiving client device to render the shared webpage including the first section and the second section.

22. The system of claim 21, wherein the generated URL is associated with HTML code that identifies which sections of the webpage are to be included in a sharing operation of the shared webpage, wherein the HTML code indicates that the first section and the second section are to be included in a sharing operation of the shared webpage

23. The system of claim 21, wherein the generated URL includes a query string associated with the second section and not the first section.

24. The system of claim 21, further comprising, control circuitry configured to:
analyze data attributes of the plurality of sections of the webpage; and
identify, based on the analyzed data attributes, the first section as required to be included in the sharing operation of the shared webpage, and identifying the second section as voluntary to be included, omitted, or replaced in the sharing operation of the shared webpage.

25. (canceled)

26. The system of claim 24, further comprising, control circuitry configured to:
determine a primary context of the webpage based on the analyzing data attributes of the plurality of sections of the webpage; and
identify each section, from the plurality of sections of the webpage, that relates to the determined primary context of the webpage with a first mark that requires inclusion of the section in the sharing operation of the shared webpage.

27. The system of claim 24, further comprising, control circuitry configured to:
determine a primary context of the webpage based on the analyzing data attributes of the plurality of sections of the webpage; and
identify each section, from the plurality of sections of the webpage, that does not relate to the determined primary context of the webpage with a second mark that permits inclusion, omission, or replacement of the section in the sharing operation of the shared webpage.

28. The system of claim 21, further comprising, control circuitry configured to:
analyze consumption history associated with the sharing client device;
detect a pattern based on the analyzed consumption history; and
select, in response to the detected pattern, the first section of the webpage as required to be included in the shared webpage.

29-33. (canceled)

34. The system of claim 21, wherein the transmitted data for the receiving client device to render the shared webpage is the first section and the second section.

35. (canceled)

36. The system of claim 21, wherein rendering of the webpage in a browser associated with the receiving client device is performed in accordance with HTML code generated for the shared webpage that indicates sharing of the first and second sections of the shared webpage.

37. The system of claim 21, further comprising, control circuitry configured to receive a selection for the second section, wherein the selection relates to replacing current content in the second section with secondary content.

38. (canceled)

39. The system of claim 37, further comprising, control circuitry configured to:
perform a real-time bidding process to receive bids from one or more third-parties for replacing the current content in the second section with the secondary content; and
select a secondary content item from the one or more third-parties based on bids received from the third-parties in real-time.

40. The system of claim 21, wherein the generated URL includes a query string, wherein the query string includes information on which sections, from the plurality of sections, of the webpage are to be rendered by the receiving client device.
